(19) United States
(12) Patent Application Publication
(10) Pub. No.: US 2024/0286129 A1
(43) Pub. Date: Aug. 29, 2024

(54) SYSTEMS AND METHODS TO DETECT PRESENCE OF FLUIDS

(71) Applicant: Nutcracker Therapeutics, Inc., Emeryville, CA (US)

(72) Inventors: Eric Chu, San Francisco, CA (US); Tamas Czimmermann, Hayward, CA (US); Kenneth Jordan, Danville, CA (US); Ximiao Wen, Hayward, CA (US)

(21) Appl. No.: 18/565,192

(22) PCT Filed: May 27, 2022
(86) PCT No.: PCT/US2022/031277

§ 371 Date: Nov. 29, 2023

Related U.S. Application Data
(60) Provisional application No. 63/196,754, filed on Jun. 4, 2021.

(30) Foreign Application Priority Data
Jun. 24, 2021 (NL) 2028528

(51) Int. Cl. B01L 3/00; G01N 15/075

(52) U.S. Cl. CPC B01L 3/502715; G01N 15/075; B01L 2300/0627; B01L 2400/0487; B01L 2400/06

(57) ABSTRACT

A system includes an optical sensor and a processor. The optical sensor has a field of view positioned to include a first fluid channel defined by a body. The processor receives a first image including a region of interest of the first fluid channel. The processor further receives a second image including the region of interest of the first fluid channel. The second image is captured after the first image. The processor further generates a comparison of the second image to the first image, generates a binary image using the comparison, and uses the binary image to determine whether a fluid is present in the region of interest of the first fluid channel. If the processor determines that the fluid is present in the region of interest of the first fluid channel, the processor ceases communication of the fluid through the first fluid channel.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Some currently available technologies for manufacturing and formulating polynucleotide therapeutics (e.g., mRNA therapeutics, etc.) may expose the products to contamination and degradation. Some available centralized production may be too costly, too slow, or susceptible to contamination for use in therapeutic formulations possibly including multiple polynucleotide species.

### SUMMARY

Development of scalable polynucleotide manufacturing, production of single patient dosages, reduction, and in some instances even elimination, of touchpoints to limit contamination, input and process tracking for meeting clinical manufacturing requirements and use in point-of-care operations may advance the use of these therapeutic modalities. Microfluidic instrumentation and processes may provide advantages in achieving these goals. It may be desirable to facilitate rapid formulation of several samples of compositions, such as for screening purposes or otherwise. Described herein are devices, systems, and methods for facilitating rapid formulation of several samples of compositions through a microfluidic system, to overcome the pre-existing challenges and achieve the benefits as described herein. Such microfluidic systems may be used for the manufacture and formulation of biomolecule-containing products, such as therapeutics for individualized care.

An implementation relates to a system that includes an optical sensor and a processor. The optical sensor has a field of view positioned to include a first fluid channel defined by a body. The processor is to receive a first image including a region of interest of the first fluid channel. The processor is further to receive a second image including the region of interest of the first fluid channel. The second image is captured after the first image. The processor is further to generate a comparison of the second image to the first image, generate a binary image using the comparison, and use the binary image to determine whether a first fluid is present in the region of interest of the first fluid channel. If the processor determines that the first fluid is present in the region of interest of the first fluid channel, the processor is to cease communication of the first fluid through the first fluid channel.

In some implementations of a system, such as that described in the preceding paragraph of this summary, the system further includes a camera. The camera includes the optical sensor.

In some implementations of a system, such as any of those described in any of the preceding paragraphs of this summary, the field of view is positioned to further include a second fluid channel defined by the body. The first image further includes a region of interest of the second fluid channel, the second image further includes the region of interest of the second fluid channel. The processor is further to deternine whether a second fluid is present in the region of interest of the second fluid channel. If the processor determines that the second fluid is present in the region of interest of the second fluid channel, the processor is to cease communication of the second fluid through the second fluid channel.

In some implementations of a system, such as any of those described in any of the preceding paragraphs of this summary, the processor is to simultaneously determine whether the first fluid is present in the region of interest of the first fluid channel and determine whether the second fluid is present in the region of interest of the second fluid channel.

In some implementations of a system, such as any of those described in any of the preceding paragraphs of this summary, the field of view is positioned to further include a third fluid channel defined by the body. The first image further includes a region of interest of the third fluid channel. The second image further includes the region of interest of the third fluid channel. The processor is further to determine whether the third fluid is present in the region of interest of the third fluid channel.

In some implementations of a system, such as any of those described in any of the preceding paragraphs of this summary, the processor is further to initiate a fluid process using the first fluid channel, the second fluid channel, and the third fluid channel if the processor determines that the first fluid is present in the region of interest of the first fluid channel, the second fluid is present the region of interest of the second fluid channel, and the third fluid is present in the region of interest of the third fluid channel.

In some implementations of a system, such as any of those described in any of the preceding paragraphs of this summary, the fluid process includes an mRNA formulation process.

In some implementations of a system, such as any of those described in any of the preceding paragraphs of this summary, the system further includes a fluid processing assembly. The fluid processing assembly has a fluid driving feature to drive the first fluid through the first fluid channel.

In some implementations of a system, such as any of those described in any of the preceding paragraphs of this summary, the processor is in communication with the fluid processing assembly.

In some implementations of a system, such as any of those described in any of the preceding paragraphs of this summary, the processor is to cease communication of the first fluid through the first fluid channel by deactivating the fluid driving feature of the fluid processing assembly.

In some implementations of a system, such as any of those described in any of the preceding paragraphs of this summary, the processor is to cease communication of the first fluid through the first fluid channel by activating a valve.

In some implementations of a system, such as any of those described in any of the preceding paragraphs of this summary, the valve is located on or in the body, downstream of the region of interest of the first fluid channel.

In some implementations of a system, such as any of those described in any of the preceding paragraphs of this summary, the system further includes a light source to illuminate the region of interest.

In some implementations of a system, such as any of those described in any of the preceding paragraphs of this summary, the processor is further to perform noise reduction on the comparison before generating the binary image.

In some implementations of a system, such as any of those described in any of the preceding paragraphs of this summary, the noise reduction includes one or more processes selected from the group consisting of blurring, sharpening, applying a gain filter, applying a contrast filter, and converting to grayscale.

In some implementations of a system, such as any of those described in any of the preceding paragraphs of this summary, the processor is to use the binary image to determine whether the first fluid is present in the region of interest of the first fluid channel by calculating a ratio.

In some implementations of a system, such as any of those described in any of the preceding paragraphs of this summary, the ratio includes a ratio of a first set of pixels to a second set of pixels. The first set of pixels includes pixels shoWing reflected light at an interface between a boundary layer of fluid in the region of interest of the fluid channel and a sidewall of the fluid channel. The second set of pixels includes pixels along an entire length of the sidewall of the fluid channel in the region of interest.

In some implementations of a system, such as any of those described in any of the preceding paragraphs of this summary, the system further includes a chip-receiving component to removably receive the body.

In some implementations of a system, such as any of those described in any of the preceding paragraphs of this summary, the system further includes the body removably coupled with the chip-receiving component.

In some implementations of a system, such as any of those described in any of the preceding paragraphs of this summary, the body includes a process chip.

In some implementations of a system, such as any of those described in any of the preceding paragraphs of this summary, the body includes a substantially translucent material surrounding the first fluid channel.

In some implementations of a system, such as any of those described in any of the preceding paragraphs of this summary, the body includes a plurality of fluid channels. The plurality of fluid channels including the first fluid channel. The body further includes a plurality of mixing chambers to mix fluids communicated along the plurality of fluid channels.

In some implementations of a system, such as any of those described in any of the preceding paragraphs of this summary, the body further includes a plurality of valves. Each valve of the plurality of valves is positioned along a corresponding fluid channel of the plurality of fluid channels. Each valve of the plurality of valves is to selectively prevent fluid from flowing in the corresponding fluid channel of the plurality of fluid channels.

In some implementations of a system, such as any of those described in any of the preceding paragraphs of this summary, the processor is to cease communication of fluid through the plurality of fluid channels by activating the plurality of valves.

Another implementation relates to a method that includes receiving a first image including a region of interest of a first fluid channel while a first fluid is being communicated toward the first fluid channel. The method further includes receiving a second image including the region of interest of the first fluid channel. The second image is captured after the first image. The method further includes generating a comparison of the second image to the first image. The method further includes generating a binary image using the comparison. The method further includes using the binary image to determine whether the first fluid is present in the region of interest of the first fluid channel. If using the binary image to determine whether the first fluid is present in the region of interest of the first fluid channel indicates that the first fluid is present in the region of interest first fluid channel, the method further includes ceasing communication of the first fluid through the first fluid channel.

In some implementations of a method, such as that described in the preceding paragraph of this summary, the first fluid channel is defined by a body. The body includes a substantially translucent material surrounding the first fluid channel.

In some implementations of a method, such as any of those described in any of the preceding paragraphs of this summary, the first fluid is substantially translucent.

In some implementations of a method, such as any of those described in any of the preceding paragraphs of this summary, the method further includes capturing the first image with an optical sensor. The method further includes capturing the second image with the optical sensor.

In some implementations of a method, such as any of those described in any of the preceding paragraphs of this summary, the optical sensor is part of a camera.

In some implementations of a method, such as any of those described in any of the preceding paragraphs of this summary, the first image further includes a region of interest of a second fluid channel while a second fluid is being communicated toward the second fluid channel. The second image further includes the region of interest of the second fluid channel. The method further includes determining whether the second fluid is present in the region of interest of the second fluid channel. If determining whether the second fluid is present in the region of interest of the second fluid channel indicates that the second fluid is present in the region of interest of the second fluid channel, the method further includes ceasing communication of the second fluid through the second fluid channel.

In some implementations of a method, such as any of those described in any of the preceding paragraphs of this summary, the following are performed simultaneously: using the binary image to determine whether the first fluid is present in the region of interest of the first fluid channel; and determining whether the second fluid is present in the region of interest of the second fluid channel.

In some implementations of a method, such as any of those described in any of the preceding paragraphs of this summary, the first image further includes a region of interest of a third fluid channel while a third fluid is being communicated toward the third fluid channel. The second image further includes the region of interest of the third fluid channel. The method further includes determining whether fluid present in the region of interest of the third fluid channel.

In some implementations of a method, such as any of those described in any of the preceding paragraphs of this summary, the method further includes initiating a fluid process using the first fluid channel, the second fluid channel, and the third fluid channel if the first fluid is present in the region of interest of the first fluid channel, the second fluid is present in the region of interest of the second fluid channel, and the third fluid is present in the region of interest of the third fluid channel.

In some implementations of a method, such as any of those described in any of the preceding paragraphs of this summary, the first fluid includes an mRNA fluid, the second fluid includes a delivery vehicle fluid, the third fluid includes a buffer fluid.

In some implementations of a method, such as any of those described in any of the preceding paragraphs of this summary, the fluid process includes an mRNA formulation process.

In some implementations of a method, such as any of those described in any of the preceding paragraphs of this summary, the method further includes activating a fluid driving feature of a fluid processing assembly to drive the first fluid toward the first fluid channel.

In some implementations of a method, such as any of those described in any of the preceding paragraphs of this summary, ceasing communication of the first fluid through the first fluid channel includes deactivating the fluid driving feature of the fluid processing assembly.

In some implementations of a method, such as any of those described in any of the preceding paragraphs of this summary, ceasing communication of the first fluid through the first fluid channel includes activating a valve.

In some implementations of a method, such as any of those described in any of the preceding paragraphs of this summary, the valve is positioned along the first fluid channel.

In some implementations of a method, such as any of those described in any of the preceding paragraphs of this summary, the valve is positioned downstream of the region of interest of the first fluid channel.

In some implementations of a method, such as any of those described in any of the preceding paragraphs of this summary, the method further includes activating a light source. The light source illuminates the region of interest of the first fluid channel.

In some implementations of a method, such as any of those described in any of the preceding paragraphs of this summary, the method further includes performing noise reduction on the comparison before generating the binary image.

In some implementations of a method, such as any of those described in any of the preceding paragraphs of this summary, the noise reduction includes one or more processes selected from the group consisting of blurring, sharpening, applying a gain filter, applying a contrast filter, and converting to grayscale.

In some implementations of a method, such as any of those described in any of the preceding paragraphs of this summary, using the binary image to determine whether the first fluid is present in the region of interest of the first fluid channel includes calculating a ratio.

In some implementations of a method, such as any of those described in any of the preceding paragraphs of this summary, the ratio includes a ratio of a first set of pixels to a second set of pixels. The first set of pixels includes pixels showing reflected light at an interface between a boundary layer of fluid in the region of interest of the fluid channel and a sidewall of the fluid channel. The second set of pixels includes pixels along an entire length of the sidewall of the fluid channel in the region of interest.

Another implementation relates to a processor-readable medium including contents that are configured to cause a processor to process data by performing a method such as any of those described in any of the preceding paragraphs of this summary.

It should be appreciated that all combinations of the foregoing concepts and additional concepts discussed in greater detail below (provided such concepts are not mutually inconsistent) are contemplated as being part of the inventive subject matter disclosed herein and to achieve the benefits as described herein.

### BRIEF DESCRIPTION OF THE DRAWINGS

The details of one or more implementations are set forth in the accompanying drawings and the description below. Other features, aspects, and advantages Will become apparent from the description, the drawings, and the claims, in which:

FIG. 1 depicts a schematic view of an example of a system including a microfluidic process chip;

FIG. 2 depicts an exploded perspective view of examples of components of the system of FIG. 1;

FIG. 3 depicts a top plan view of an example of a process chip that may be incorporated into the system of FIG. 1;

FIG. 4 schematically illustrates an example of a method of manufacturing an mRNA therapeutic composition;

FIG. 5 shows a top plan view of examples of mixing stages that may be incorporated into a process chip that is used for formulation of mRNA with a delivery vehicle;

FIG. 6 depicts a schematic view of an example of a system including an instrument for processing fluids on a process chip and an additional fluid processing subsystem:

FIG. 7 depicts a schematic view of an example of a system including an instrument with a first fluid processing assembly and a second fluid processing assembly;

FIG. 8 depicts a schematic view of an example of a system that may be used to prepare several samples of compositions;

FIG. 9 depicts a flow chart of an example of a method that may be performed using the system of FIG. 8;

FIG. 10A depicts a schematic view of an example of components that may be used to detect the presence of fluids within a region of interest in a process chip, in a first state of operation;

FIG. 10B depicts a schematic view of the components of FIG. 10A, in a second state of operation;

FIG. 10C depicts a schematic view of the components of FIG. 10A, in a third state of operation;

FIG. 11 depicts a schematic view of an example of an algorithm that may be used to track movement of an item within a region of interest; and

FIG. 12 depicts a flow chart of an example of a method that may be performed detect the presence of fluid in a region of interest within a fluid processing system.

### DETAILED DESCRIPTION

In some aspects, apparatuses and methods are disclosed herein for processing therapeutic polynucleotides. In particular, these apparatuses and methods may be closed path apparatuses and methods that are configured to minimize or eliminate manual handling during operation. The closed path apparatuses and methods may provide a nearly entirely aseptic environment, and the components may provide a sterile path for processing from initial input (e.g., template) to output (e.g., compounded therapeutic). Material inputs (e.g., nucleotides, and any chemical components) into the apparatus may be sterile; and may be input into the system without requiring virtually any manual interaction.

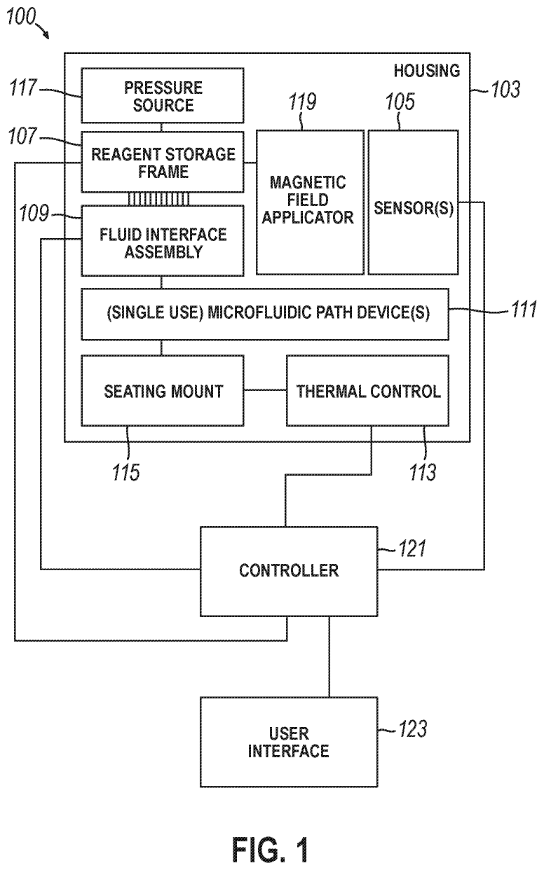

The apparatuses and methods described herein may be used to generate therapeutics at rapid cycle times at high degree of reproducibility. The apparatuses described herein may be configured to provide, in a single integrated apparatus, synthesis, purification, dialysis, compounding, and concentration of one or more therapeutic compositions. Alternatively, one or more of these processes may be carried out in two or more apparatuses as described herein. In some scenarios, the therapeutic compositions may include therapeutic polynucleotides, such as, for example, ribonucleic acids or deoxyribonucleic acids. The polynucleotides may include only natural nucleotide units or may include any kind of synthetic, semi-synthetic, or modified nucleotide units. All or some of the processing steps may be performed in an unbroken fluid processing pathway, which may be configured as one or a series of consumable microfluidic path device(s)—in some instances also referred to herein as a process chip or a biochip (though the chip need not necessarily be used in bio-related applications). The process chip in in some examples may be removably installed in an instrument that is part of a larger microfluidic system, such as that shown in FIG. 1). The disclosed apparatuses and methods may be used for the synthesis of patient-specific therapeutics, including compounding, at a point of care (e.g., hospital, clinic, pharmacy, etc.).

### I. Terminology

Throughout this specification and the claims which follow, unless the context requires otherwise, the word “comprise,” and variations such as “comprises” and “comprising” means various components may be co-jointly employed in the methods and articles (e.g., compositions and apparatuses including device and methods). For example, the term “comprising” will be understood to imply the inclusion of any stated elements or steps but not the exclusion of any other elements or steps. In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components, or sub-steps.

As used herein, the singular forms “a,” “an,” and “the” are intended to include the plural forms as well, unless the context clearly indicates otherwise. As used herein, the term “and/or” includes any and all combinations of one or more of the associated listed items and may be abbreviated as “/”.

Spatially relative terms, such as “under,” “below,” “lower,” “over,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the term “under” may encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

When a feature or element is herein referred to as being “on” another feature or element, it may be directly on the other feature or element or intervening features and/or elements may also be present. In contrast, when a feature or element is referred to as being “directly on” another feature or element, there are no intervening features or elements present. When a feature or element is referred to as being “connected,” “attached,” or “coupled” to another feature or element, it may be directly connected, attached, or coupled to the other feature or element or intervening features or elements may be present. In contrast, when a feature or element is referred to as being “directly connected,” “directly attached,” or “directly coupled” to another feature or element, there are no intervening features or elements present. Although described or shown with respect to one embodiment, the features and elements so described or shown may apply to other embodiments. It will also be appreciated by those skilled in the art that references to a structure or feature that is disposed “adjacent” another feature may have portions that overlap or underlie the adjacent feature.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is ±0.1% of the stated value (or range of values), ±1% of the stated value (or range of values), ±2% of the stated value (or range of values), ±5% of the stated value (or range of values), ±10% of the stated value (or range of values), etc. Any numerical values given herein should also be understood to include about or approximately that value unless the context indicates otherwise. For example, if the value “10” is disclosed, then “about 10” is also disclosed. Any numerical range recited herein is intended to include all sub-ranges subsumed therein.

It is also understood that when a value is disclosed that “less than or equal to” the value, “greater than or equal to the value,” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although the terms “first” and “second” may be used herein to describe various features/elements (including steps), these features/elements should not be limited by these terms, unless the context indicates otherwise. These terms are used to distinguish one feature/element from another feature/element, and unless specifically pointed out, do not denote a certain order. Thus, a first feature/element discussed below could be termed a second feature/element, and similarly, a second feature/element discussed below could be termed a first feature/element without departing from the teachings of the present invention.

As used herein, the terms “system,” “apparatus,” and “device” may be read as being interchangeable with each other. A system, apparatus, and device may each include a plurality of components having various kinds of structural and/or functional relationships with each other.

As used herein, “polynucleotide” refers to a nucleic acid molecule containing multiple nucleotides and generally refers both to “oligonucleotides” (a polynucleotide molecule of 18-25 nucleotides in length) and polynucleotides of 26 or more nucleotides. Aspects of this disclosure include compositions including oligonucleotides having a length of 18-25 nucleotides (e.g., 18-mers, 19-mers, 20-mers, 21-mers, 22-mers, 23-mers, 24-mers, or 25-mers), or medium-length polynucleotides having a length of 26 or more nucleotides (e.g., polynucleotides of 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, about 65, about 70, about 75, about 80, about 85, about 90, about 95, about 100, about 110, about 120, about 130, about 140, about 150, about 160, about 170, about 180, about 190, about 200, about 210, about 220, about 230, about 240, about 250, about 260, about 270, about 280, about 290, or about 300 nucleotides), or long polynucleotides having a length greater than about 300 nucleotides (e.g., polynucleotides of between about 300 to about 400 nucleotides, between about 400 to about 500 nucleotides, between about 500 to about 600 nucleotides, between about 600 to about 700 nucleotides, between about 700 to about 800 nucleotides, between about 800 to about 900 nucleotides, between about 900 to about 1000 nucleotides, between about 300 to about 500 nucleotides, between about 300 to about 600 nucleotides, between about 300 to about 700 nucleotides, between about 300 to about 800 nucleotides, between about 300 to about 900 nucleotides, or about 1000 nucleotides in length, or even greater than about 1000 nucleotides in length. Where a polynucleotide is double-stranded, its length may be similarly described in terms of base pairs.

As used herein “amplification” may refer to polynucleotide amplification. Amplification may include any suitable method for amplification of a polynucleotide and includes, but is not limited to, multiple displacement amplification (MDA), polymerase chain reaction (PCR) amplification, Loop Mediated Isothermal Amplification (LAMP), Nucleic Acid Sequence Based Amplification, Strand Displacement Amplification, Rolling Circle Amplification, and Ligase Chain Reaction.

As used herein a “cassette” (e.g., a synthetic in vitro transcription facilitator cassette) refers to a polynucleotide sequence which may include or be operably linked to one or more expression elements such as an enhancer, a promoter, a leader, an intron, a 5′ untranslated region (UTR), a 3′ UTR, or a transcription termination sequence. In some aspects, a cassette comprises at least a first polynucleotide sequence capable of initiating transcription of an operably linked second polynucleotide sequence (which may comprise a template) and optionally a transcription termination sequence operably linked to the second polynucleotide sequence. The template, as described below, may comprise a sequence of interest, for example, an open reading frame (“ORF”) of interest. The cassette may be provided as a single element or as two or more unlinked elements.

As used herein, a “template” refers to a nucleic acid sequence that contains a sequence of interest for preparing a therapeutic polynucleotide according to the disclosed methods. Templates may be, but are not limited to, a double stranded DNA (dsDNA), an engineered plasmid construct, a cDNA sequence, or a linear nucleic acid sequence (for example, a linear template generated by PCR or by annealing chemically synthesized oligonucleotides). The template may, in certain aspects, be integrated into a “cassette” as described above.

As used herein, the term “sequence of interest” refers to a polynucleotide sequence, the use of which may be deemed desirable for a suitable purpose, in particular, for the manufacture of an mRNA for a therapeutic use, and includes but is not limited to, coding sequences of structural genes, and non-coding regulatory sequences that do not encode and mRNA or protein product.

As used herein, “in vitro transcription” or “IVT” refer to the process whereby transcription occurs in vitro in a non-cellular system to produce synthetic RNA molecules (e.g., synthetic mRNA) for use in various applications, including for therapeutic delivery to a subject, for example, as a therapeutic polynucleotide, which may be part of, or may be used to form, a therapeutic polynucleotide composition as described below. The therapeutic polynucleotide, (e.g., synthetic RNA molecules (transcription product)) generated may be combined with a delivery vehicle to form a therapeutic polynucleotide composition. Synthetic transcription products include mRNAs, antisense RNA molecules, shRNA, circular RNA molecules, ribozymes, and the like. An IVT reaction may use a purified linear DNA template comprising a promoter sequence and the sequence of the open reading frame (ORF) of a sequence of interest, ribonucleotide triphosphates or modified ribonucleotide triphosphates, a buffer system that includes DTT and magnesium ions, and a phage RNA polymerase.

As used herein a “therapeutic polynucleotide” refers to a polynucleotide (e.g., an mRNA) that may be part of a therapeutic polynucleotide composition for delivery to a subject to treat a symptom, disease, or condition in a subject; prevent a symptom, disease, or condition in a subject; or to improve or otherwise modify the subject's health.

As used herein a “therapeutic polynucleotide composition” (or “therapeutic composition” for short) may refer to a composition including one or more therapeutic polynucleotides (e.g., mRNA) encapsulated by a delivery vehicle, which composition may be administered to a subject in need thereof using any suitable administration routes, such as intratumoral, intramuscular, etc. injection. An example of a therapeutic polynucleotide composition is an mRNA (therapeutic) nanoparticle comprising at least one mRNA encapsulated by a delivery vehicle molecule. An mRNA vaccine is one example of a therapeutic polynucleotide composition.

As used herein, “delivery vehicle” refers to any substance that facilitates, at least in part, the in vivo, in vitro, or ex vivo delivery of a polynucleotide (e.g., therapeutic polynucleotide) to targeted cells or tissues (e.g., tumors, etc.). Referring to something as a delivery vehicle need not exclude the possibility of the delivery vehicle also having therapeutic effects. Some versions of a delivery vehicle may provide additional therapeutic effects. In some versions, a delivery vehicle may be a peptoid molecule, such as an amino-lipidated peptoid molecule, that may be used to at least partially encapsulate mRNA. The term “DV” will also be used herein as a shorthand for “delivery vehicle.”

As used herein, “joining” refers to methods such as ligation, synthesis, primer extension, annealing, recombination, or hybridization use to couple one component to another.

As used herein “purifying” refers to physical and/or chemical separation of a component (e.g., particles) of other unwanted components (e.g., contaminating substances, fragments, etc.).

As used herein, the term “substantially free” as used with respect to a given substance, includes 100% free of a given substance, or which comprises less than about 1.0%, or less than about 0.5%, or less than about 0.1% of the given substance.

As used herein, “substantially translucent” means that at least 70% (including in some instances transparency—e.g., 100%) of light is transmitted through a material.

### II. Overview of System Including Microfluidic Process Chip

FIG. 1 depicts examples of various components that may be incorporated into a system (100). System (100) of this example includes a housing (103) enclosing a seating mount (115) that may removably hold one or more microfluidic process chips (111). In other words, system (100) includes a chip-receiving component that is configured to removably accommodate a process chip (111), where the process chip (111) itself defines one or more microfluidic channels or fluid pathways. Components of system (100) (e.g., within housing (103)) that fluidically interact with process chip (111) may include fluid channels or pathways that are not necessarily considered microfluidic (e.g., with such fluid channels or pathways being larger than the microfluidic channels or fluid pathways in process chip (111)). In some versions, process chips (111) are provided and utilized as single-use devices, while the rest of system (100) is reusable. Housing (103) may be in the form of a chamber, enclosure, etc., with an opening that may be closed (e.g., via a lid or door, etc.) to thereby seal the interior. Housing (103) may enclose a thermal regulator and/or may be configured to be enclosed in a thermally-regulated environment (e.g., a refrigeration unit, etc.). Housing (103) may form an aseptic barrier. In some variations, housing (103) may form a humidified or humidity-controlled environment. In addition, or in the alternative, system (100) may be positioned in a cabinet (not shown). Such a cabinet may provide a temperature-regulated (e.g., refrigerated) environment. Such a cabinet may also provide air filtering and air flow management and may promote reagents being kept at a desired temperature through the manufacturing process. In addition, such a cabinet may be equipped with UV lamps for sterilization of process chip (111) and other components of system (100). Other suitable features may be incorporated into a cabinet that houses system (100).

In some scenarios, the assembly formed by housing (103) and the components of system (100) that are within housing (103), without process chip (111), may be considered as being an “instrument.” While controller (121) and user interface (123) are shown in FIG. 1 as being outside of housing (103), controller (121) and user interface (123) may in fact be provided in or on housing (103) and may thus also form part of the instrument. As described in greater detail below, this instrument may removably receive process chip (111) via a seating mount (115). When process chip (111) is seated in seating mount (115), the instrument and process chip (111) cooperate to together form system (100). When process chip (111) is removed from seating mount (115), the portion of system (100) that is left may be regarded as the “instrument.” The instrument, the system (100), and process chip (111) may each be considered an “apparatus.” The term “apparatus” may thus be read to include the instrument by itself, a process chip (111) by itself, the combination of the instrument and process chip (111), some other combination of components of system (100), or some other permutation of system (100) or components thereof.

Seating mount (115) may be configured to secure process chip (111) using one or more pins or other components configured to hold process chip (I 11) in a fixed and predefined orientation. Seating mount (115) may thus facilitate process chip (111) being held at an appropriate position and orientation in relation to other components of system (100). In the present example, seating mount (115) is configured to hold process chip (111) in a horizontal orientation, such that process chip (111) is parallel with the ground.

In some variations, a thermal control (113) may be located adjacent to seating mount (115), to modulate the temperature of any process chip (111) mounted in seating mount (115). Thermal control (113) may include a thermoelectric component (e.g., Peltier device, etc.) and/or one or more heat sinks for controlling the temperature of all or a portion of any process chip (111) mounted in seating mount (115). In some variations, more than one thermal control (113) may be included, such as to separately regulate the temperature of different ones of one or more regions of process chip (111). Thermal control (113) may include one or more thermal sensors (e.g., thermocouples, etc.) that may be used for feedback control of process chip (111) and/or thermal control (113).

As shown in FIG. 1, a fluid interface assembly (109) couples process chip (111) with a pressure source (117), thereby providing one or more paths for fluid (e.g., gas) at a positive or negative pressure to be communicated from pressure source (117) to one or more interior regions of process chip (111) as will be described in greater detail below. While only one pressure source (117) is shown, system (100) may include two or more pressure sources (117). In some scenarios, pressure may be generated by one or more sources other than pressure source (117). For instance, one or more vials or other fluid sources within reagent storage frame (107) may be pressurized. In addition, or in the alternative, reactions and/or other processes carried out on process chip (111) may generate additional fluid pressure. In the present example, fluid interface assembly (109) also couples process chip (111) with a reagent storage frame (107), thereby providing one or more paths for liquid reagents, etc., to be communicated from reagent storage frame (107) to one or more interior regions of process chip (111) as will be described in greater detail below.

In some versions, pressurized fluid (e.g., gas) from at least one pressure source (117) reaches fluid interface assembly (109) via reagent storage frame (107), such that reagent storage frame (107) includes one or more components interposed in the fluid path between pressure source (117) and fluid interface assembly (109). In some versions, one or more pressure sources (117) are directly coupled with fluid interface assembly, such that the positively pressurized fluid (e.g., positively pressurized gas) or negatively pressurized fluid (e.g., suction or other negatively pressurized gas) bypasses reagent storage frame (107) to reach fluid interface assembly (109). Regardless of whether the fluid interface assembly (109) is interposed in the fluid path between pressure source (117) and fluid interface assembly (109), fluid interface assembly (109) may be removably coupled to the rest of system (100), such that at least a portion of fluid interface assembly (109) may be removed for sterilization between uses. As described in greater detail below, pressure source (117) may selectively pressurize one or more chamber regions on process chip (111). In addition, or in the alternative, pressure source may also selectively pressurize one or more vials or other fluid storage containers held by reagent storage frame (107).

Reagent storage frame (107) is configured to contain a plurality of fluid sample holders, each of which may hold a fluid vial that is configured to hold a reagent (e.g., nucleotides, solvent, water, etc.) for delivery to process chip (111). In some versions, one or more fluid vials or other storage containers in reagent storage frame (107) may be configured to receive a product from the interior of the process chip (111). In addition, or in the alternative, a second process chip (111) may receive a product from the interior of a first process chip (111), such that one or more fluids are transferred from one process chip (111) to another process chip (111). In some such scenarios, the first process chip (111) may perform a first dedicated function (e.g., synthesis, etc.) while the second process chip (111) performs a second dedicated function (e.g., encapsulation, etc.). Reagent storage frame (107) of the present example includes a plurality of pressure lines and/or a manifold configured to divide one or more pressure sources (117) into a plurality of pressure lines that may be applied to process chip (111). Such pressure lines may be independently or collectively (in sub-combinations) controlled.

Fluid interface assembly (109) may include a plurality of fluid lines and/or pressure lines where each such line includes a biased (e.g., spring-loaded) holder or tip that individually and independently drives each fluid and/or pressure line to process chip (111) when process chip (111) is held in seating mount (115). Any associated tubing (e.g., the fluid lines and/or the pressure lines) may be part of fluid interface assembly (109) and/or may connect to fluid interface assembly (109). In some versions, each fluid line comprises a flexible tubing that connects between reagent storage frame (107), via a connector that couples the vial to the tubing in a locking engagement (e.g., ferrule) and process chip (111). In some versions, the ends of the fluid lines/pressure lines may be configured to seal against process chip (111) (e.g., at a corresponding sealing port formed in process chip (111)), as described below. In the present example, the connections between pressure source (117) and process chip (111), and the connections between vials in reagent storage frame (107) and process chip (111), all form sealed and closed paths that are isolated when process chip (111) is seated in seating mount (115). Such sealed, closed paths may provide protection against contamination when processing therapeutic polynucleotides.

The vials of reagent storage frame (107) may be pressurized (e.g., >1 atm pressure, such as 2 atm, 3 atm, 5 atm, or higher). In some versions, the vials may be pressurized by pressure source (117). Negative or positive pressure may thus be applied. For example, the fluid vials may be pressurized to between about 1 and about 20 psig (e.g., 5 psig, 10 psig, etc.). Alternatively, a vacuum (e.g., about −7 psig or about 7 psia) may be applied to draw fluids back into the vials (e.g., vials serving as storage depots) at the end of the process. The fluid vials may be driven at lower pressure than the pneumatic valves as described below, which may prevent or reduce leakage. In some variations, the difference in pressure between the fluid and pneumatic valves may be between about 1 psi and about 25 psi (e.g., about 3 psi, about 5 psi, 7 psi, 10 psi, 12 psi, 15 psi, 20 psi, etc.).

System (100) of the present example further includes a magnetic field applicator (119), which is configured to create a magnetic field at a region of the process chip (111). Magnetic field applicator (119) may include a movable head that is operable to move the magnetic field to thereby selectively isolate products that are adhered to magnetic capture beads within vials or other storage containers in reagent storage frame (107).

System (100) of the present example further includes one or more sensors (105). In some versions, such sensors (105) include one or more cameras and/or other kinds of optical sensors. Such sensors (105) may sense one or more of a barcode, a fluid level within a fluid vial held within reagent storage frame (107), fluidic movement within a process chip (111) that is mounted within seating mount (115), and/or other optically detectable conditions. In versions where a sensor (105) is used to sense barcodes, such barcodes may be included on vials of reagent storage frame (107), such that sensor (105) may be used to identify vials in reagent storage frame (107). In some versions, a single sensor (105) is positioned and configured to simultaneously view such barcodes on vials in reagent storage frame (107), fluid levels in vials in reagent storage frame (107), fluidic movement within a process chip (111) that is mounted within seating mount (115), and/or other optically detectable conditions. In some other versions, more than one sensor (105) is used to view such conditions. In some such versions, different sensors (105) may be positioned and configured to separately view corresponding optically detectable conditions, such that a sensor (105) may be dedicated to a particular corresponding optically detectable condition.

In versions where sensors (105) include at least one optical sensor, visual/optical markers may be used to estimate yield. For example, fluorescence may be used to detect process yield or residual material by tagging with fluorophores. In addition, or in the alternative, dynamic light scattering (DLS) may be used to measure particle size distributions within a portion of the process chip (111) (e.g., such as a mixing portion of process chip (111)). In some variations, sensor (105) may provide measurements using one or two optical fibers to convey light (e.g., laser light) into process chip (111); and detect an optical signal coming out of process chip (111). In versions where sensor (105) optically detects process yield or residual material, etc., sensor (105) may be configured to detect visible light, fluorescent light, an ultraviolet (UV) absorbance signal, an infrared (IR) absorbance signal, and/or any other suitable kind of optical feedback.

In versions where sensors (105) include at least one optical sensor that is configured to capture video images, such sensors (105) may record at least some activity on process chip (111). For example, an entire run for synthesizing and/or processing a material (e.g., a therapeutic RNA) may be recorded by one or more video sensors (005), including a video sensor (105) that may visualize process chip (111) (e.g., from above). Processing on process chip (111) may be visually tracked and this video record may be retained for later quality control and/or processing. Thus, the video record of the processing may be saved, stored, and/or transmitted for subsequent review and/or analysis. In addition, as will be described in greater detail below, the video may be used as a real-time feedback input that may affect processing using at least visually observable conditions captured in the video.

System (100) of the present example may be controlled by a controller (121). Controller (121) may include one or more processors, one or more memories, and various other suitable electrical components. In some versions, one or more components of controller (121) (e.g., one or more processors, etc.) is/are embedded within system (100) (e.g., contained within housing (103)). In addition, or in the alternative, one or more components of controller (121) (e.g., one or more processors, etc.) may be detachably attached or detachably connected with other components of system (100). Thus, at least a portion of controller (121) may be removable. Moreover, at least a portion of controller (121) may be remote from housing (103) in some versions.

The control by controller (121) may include activating pressure source (117) to apply pressure through process chip (111) to drive fluidic movement, among other tasks. Controller (121) may be completely or partially outside of housing (103); or completely or partially inside of housing (103). Controller (121) may be configured to receive user inputs via a user interface (123) of system (100); and provide outputs to users via user interface (123). In some versions, controller (121) is fully automated to a point where user inputs are not needed. In some such versions, user interface (123) may provide only outputs to users. User interface (123) may include a monitor, a touchscreen, a keyboard, and/or any other suitable features. Controller (121) may coordinate processing, including moving one or more fluid(s) onto and on process chip (111), mixing one or more fluids on process chip (111), adding one or more components to process chip (111), metering fluid in process chip (111), regulating the temperature of process chip (111), applying a magnetic field (e.g., when using magnetic beads), etc. Controller (121) may receive real-time feedback from sensors (105) and execute control algorithms in accordance with such feedback from sensors (105). Such feedback from sensors (105) may include, but need not be limited to, identification of reagents in vials in reagent storage frame (107), detected fluid levels in vials in reagent storage frame (107), detected movement of fluid in process chip (111), fluorescence of fluorophores in fluid in process chip (111), etc. Controller (121) may include software, firmware and/or hardware. Controller (121) may also communicate with a remote server, e.g., to track operation of the apparatus, to re-order materials (e.g., components such as nucleotides, process chips (111), etc.), and/or to download protocols, etc.

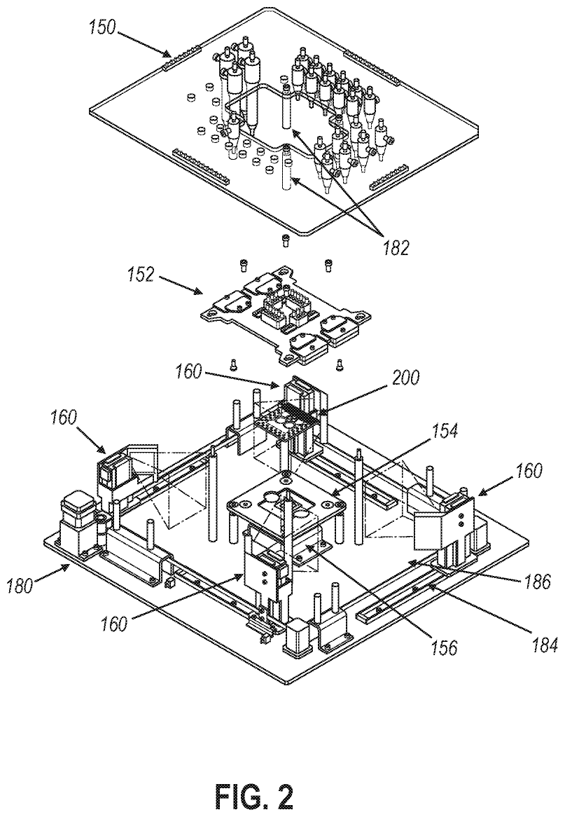

FIG. 2 shows examples of certain forms that may be taken by various components of system (100). In particular, FIG. 2 shows a reagent storage frame (150), a fluid interface assembly (152), a seating mount (154), a thermal control (156), and a process chip (200). Reagent storage frame (150), fluid interface assembly (152), seating mount (154), thermal control (156), and process chip (200) of this example may be configured and operable just like reagent storage frame (107), fluid interface assembly (109), seating mount (115), thermal control (113), and process chip (111), respectively, described above. These components are secured relative to a base (180). A set of rods (182) support reagent storage frame (150) over fluid interface assembly (152).

As shown in FIG. 2, a set of optical sensors (160) are positioned at four respective locations along base (180). Optical sensors (160) may be configured and operable like sensors (105) described above. Optical sensors (160) may include off-the-shelf cameras or any other suitable kinds of optical sensors. Optical sensors (160) are positioned such that fluid vials held within reagent storage frame (150) are within the field of view of one or more of optical sensors (160). In addition, process chip (200) is within the field of view of one or more of optical sensors (160). Each optical sensor (160) is movably secured to base (180) via a corresponding rail (184) (e.g., in a gantry arrangement), such that each optical sensor (160) is configured to translate laterally along each corresponding rail (184). A linear actuator (186) is secured to each optical sensor (160) and is thereby operable to drive lateral translation of each optical sensor (160) along the corresponding rail (184). Each actuator (186) may be in the form of a drive belt, a drive chain, a drive cable, or any other suitable kind of structure. Controller (121) may drive operation of actuators (186). Optical sensors (160) may be moved along rails (184) during operation of system (100) in order to facilitate viewing of the appropriate regions of vials in reagent storage frame (150) and/or process chip (200). In some scenarios, optical sensors (160) move in unison along corresponding rails (184). In some other scenarios, optical sensors (160) move independently along corresponding rails (184).

While optical sensors (160) are shown in FIG. 2 as being mounted to base (180), optical sensors (160) may be positioned elsewhere within system (100), in addition to or as an alternative to being mounted to base (180). For instance, some versions of reagent storage frame (107) may include one or more optical sensors (160) positioned and configured to provide an overhead field of view. In some such versions, such optical sensors (160) may be mounted to rails, movable cantilever arms, or other structures that allow such optical sensors (160) to be repositioned during operation of system (100). Optical sensors (160) may be positioned in any other suitable locations. While not shown, system (100) may also include one or more sources of light (e.g., electroluminescent panels, etc.) to provide illumination that aids in optical sensing by optical sensors (160).

In some versions, one or more mirrors are used to facilitate visualization of components of system (100) by optical sensors (160). Such mirrors may allow optical sensors (160) to view components of system (100) that may not otherwise be within the field of view of sensors (160). Such mirrors may be placed directly adjacent to optical sensors (160). In addition, or in the alternative, such mirrors may be placed adjacent to one or more components of system (100) that are to be viewed by optical sensors (160).

In use of system (100), an operator may select a protocol to run (e.g., from a library of preset protocols), or the user may enter a new protocol (or modify an existing protocol), via user interface (123). From the protocol, controller (121) may instruct the operator which kind of process chip (111) to use, what the contents of vials in reagent storage frame (107) should be, and where to place the vials in reagent storage frame (107). The operator may load process chip (111) into seating mount (115); and load the desired reagent vials and export vials into reagent storage frame (107). System (100) may confirm the presence of the desired peripherals, identify process chip (111), and scan identifiers (e.g., barcodes) for each reagent and product vial in reagent storage frame (107), facilitating the vials to match the bill-of-reagents for the selected protocol. After confirming the starting materials and equipment, controller (121) may execute the protocol. During execution, valves and pumps are actuated to deliver reagents as described in greater detail below, reagents are blended, temperature is controlled, and reactions occur, measurements are made, and products are pumped to destination vials in reagent storage frame (107).

### III. Example of Process Chip

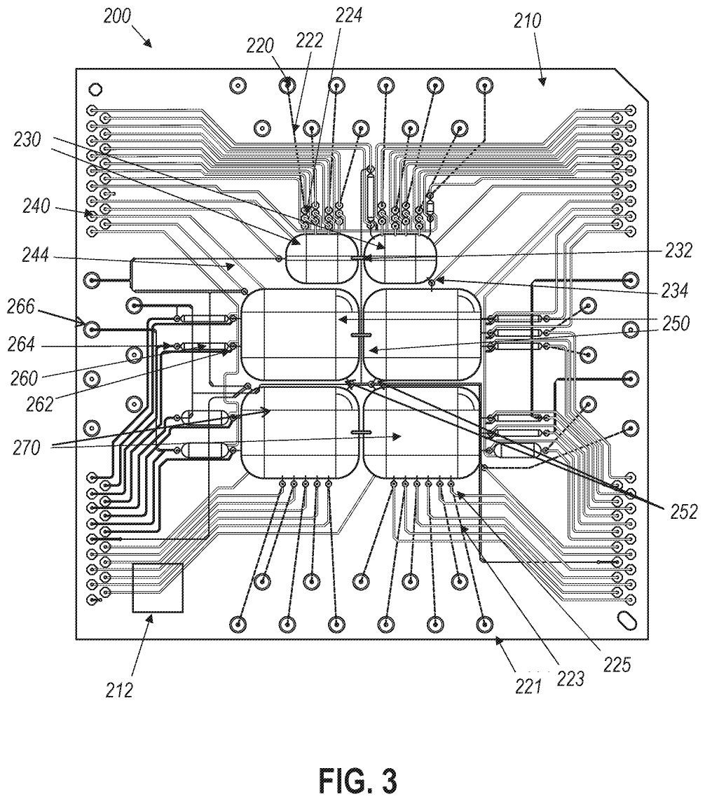

FIG. 3 depicts the example of a process chip (200) in further detail. In combination with the rest of system (100), process chip (200) may be utilized to provide in vitro synthesis, purification, concentration, formulation, and analysis of therapeutic compositions, including but not limited to therapeutic polynucleotides and therapeutic polynucleotide compositions. As shown in FIG. 3, process chip (200) of this example includes a plurality of fluid ports (220). Each fluid port (220) has an associated fluid channel (222) formed in process chip (200), such that fluid communicated into fluid port (220) will flow through the corresponding fluid channel (222). As described in greater detail below, each fluid port (220) is configured to receive fluid from a corresponding fluid line (206) from fluid interface assembly (109). In the present example, each fluid channel (222) leads to a valve chamber (224), which is operable to selectively prevent or permit fluid from the corresponding fluid channel (222) to be further communicated along process chip (200) as will be described in greater detail below.

As also shown in FIG. 3, process chip (200) of this example includes a plurality of additional chambers (230, 250, 270) that may be used to serve different purposes during the process of producing the therapeutic composition as described herein. By way of example only, such additional chambers (230, 250, 270) may be used to provide synthesis, purification, dialysis, compounding, and concentration of one or more therapeutic compositions; or to perform any other suitable function(s). Fluid may be communicated from one chamber (230) to another chamber (230) via a fluidic connector (232). In some versions, fluidic connector (232) is operable like a valve between an open and closed state (e.g., similar to valve chamber (224)). In some other versions, fluidic connector (232) remains open throughout the process of making the therapeutic composition. In the present example, chambers (230) are used to provide synthesis of polynucleotides, though chambers (230) may alternatively serve any other suitable purpose(s).

In the example shown in FIG. 3, another valve chamber (234) is interposed between one of chambers (230) and one of chambers (250), such that fluid may be selectively communicated from chamber (230) to chamber (250). Chambers (250) are provided in a pair and are coupled with each other such that process chip (200) may communicate the fluid back and forth between chambers (250). While a pair of chambers (250) are provided in the present example, any other suitable number of chambers (250) may be used, including just one chamber (250) or more than two chambers (250). Chambers (250) may be used to provide purification of the fluid and/or may serve any of the other various purposes described herein; and may have any suitable configuration. In versions where a chamber (250) is used for purification, chamber (250) may include a material that is configured to absorb selected moieties from a fluidic mixture in chamber (250). In some such versions, the material may include a cellulose material, which may selectively absorb double-stranded mRNA from a mixture. In some such versions, the cellulose material may be inserted in only one chamber (250) of a pair of chambers (250), such that upon mixing the fluid from the first chamber (250) of the pair to the second chamber (250), mRNA and/or some other component may be effectively removed from the fluidic mixture, which may then be transferred to another pair of chambers (270) further downstream for further processing or export. Alternatively, chambers (250) may be used for any other suitable purpose.

Additional valve chambers (252) are interposed between each chamber (250) and a corresponding chamber (270), such that fluid may be selectively communicated from chambers (250) to chambers (270) via valve chambers (252). Chambers (270) are also coupled with each other such that process chip (200) may communicate the fluid back and forth between chambers (270). Chambers (270) may be used to provide mixing of the fluid and/or may serve any of the other various purposes described herein; and may have any suitable configuration.

As shown in FIG. 3, chambers (270) are also coupled with additional fluid ports (221) via corresponding fluid channels (223) and valve chambers (225). Fluid ports (221), fluid channels (223), and valve chambers (225) may be configured an operable like fluid ports (220), fluid channels (222), and valve chambers (224) described above. In some versions, fluid ports (221) are used to communicate additional fluids to chambers (270). In addition, or in the alternative, fluid ports (221) may be used to communicate fluid from process chip (200) to another device. For instance, fluid from chambers (270) may be communicated via fluid ports (221) directly to another process chip (200), to one or more vials in reagent storage frame (107), or elsewhere.

Process chip (200) further includes several reservoir chambers (260). In this example, each reservoir chamber (260) is configured to receive and store fluid that is being communicated to or from a corresponding chamber (250, 270). Each reservoir chamber (260) has a corresponding inlet valve chamber (262) and outlet valve chamber (264). Each inlet valve chamber (262) is interposed between reservoir chamber (260) and the corresponding chamber (250, 270) and is thereby operable to permit or prevent the flow of fluid between reservoir chamber (260) and the corresponding chamber (250, 270). Each outlet valve chamber (264) is operable to meter the flow of fluid between reservoir chamber (260) and a corresponding fluid port (266). In some versions, each fluid port (266) is configured to communicate fluid from a corresponding vial in reagent storage frame (107) to a corresponding reservoir chamber (260). In addition, or in the alternative, each fluid port (266) may be configured to communicate fluid from a corresponding reservoir chamber (260) to a corresponding vial in reagent storage frame (107). In the present example, reservoir chambers (260) are used to provide metering of fluid communicated to and/or from process chip (200). Alternatively, reservoir chambers (260) may be utilized for any other suitable purposes, including but not limited to pressurizing fluid that is communicated to and/or from process chip (200).

As also shown in FIG. 3, process chip (200) of this example includes a plurality of pressure ports (240). Each pressure port (240) has an associated pressure channel (244) formed in process chip (200), such that pressurized gas communicated through pressure port (240) will be further communicated through the corresponding pressure channel (244). As described in greater detail below, each pressure port (240) is configured to receive pressurized gas from a corresponding pressure line (208) from fluid interface assembly (109). In the present example, each pressure channel (244) leads to a corresponding chamber (224, 225, 230, 234, 250, 252, 260, 262, 264, 270) to thereby provide valving or peristaltic pumping via such chambers (224, 225, 230, 234, 250, 252, 260, 262, 264, 270) as described in greater detail below.

Process chip (200) may also include electrical contacts, pins, pin sockets, capacitive coils, inductive coils, or other features that are configured to provide electrical communication with other components of system (100). In the example shown in FIG. 3, process chip (200) includes an electrically active region (212) includes such electrical communication features. Electrically active region (212) may further include electrical circuits and other electrical components. In some versions, electrically active region (212) may provide communication of power, data, etc. While electrically active region (212) is shown in one particular location on process chip, electrically active region (212) may alternatively be positioned at any other suitable location or locations. In some versions, electrically active region (212) is omitted.

### IV. Example of Method of Manufacture of Therapeutics

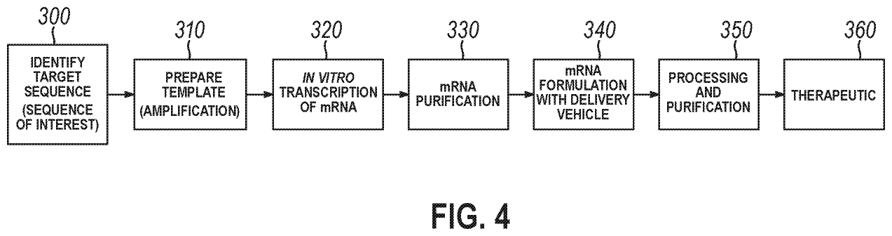

The above-described system may be used for the manufacture of mRNA-based therapeutics as described herein or other compositions. An example of a method for making an mRNA therapeutic is depicted in FIG. 4. In this example method, a target sequence (“sequence of interest”) is identified, as shown in block (300) of FIG. 4. A template comprising the target sequence (“sequence of interest”) may then be prepared and amplified (“amplification”), as shown in bock (310). Via in vitro transcription of mRNA as shown in block (320), mRNA is manufactured using a template comprising the target sequence. The resulting mRNA comprising the sequence of interest may then be purified, as shown in block (330), and then formulated with a DV, as shown in block (340). The resulting formulation comprising mRNA may then be further processed and optionally purified, as shown in block (360), for a therapeutic use, as shown in block (360). Examples of details of the method shown in FIG. 4 will be described further below.

Therapeutic uses of compositions yielded by the method shown in FIG. 4 may include, for example, cell therapies, oncological treatments, protein replacement, vaccines, expression of effector proteins, inducement of loss of function through expression of dominant negative proteins, and gene/genome editing. In addition to their high potency, mRNA therapeutics may also have benefits related to their rapid development cycle, standardized manufacturing, transient expression, and low risk of genomic integration. The methods and apparatuses described herein may be used to manufacture mRNA therapeutics for one or more of these categories of therapeutics.

### A. Identify Sequence of Interest

Any suitable method and criteria may be used to identify a sequence of interest for the part of the method represented by block (300) of FIG. 4. In some instances, the sequence of interest may be a short piece of DNA that encodes for a some or all of a product molecule (RNA or protein). The sequence of interest may be based, at least in part, on a specific patient's genetics (e.g., genotype), including generating a specific mRNA composition based on the patient's own sequence. The sequence of interest may additionally or alternatively be based, at least in part, on a specific patient's phenotype (e.g., based on the category a patient falls into, such as risk factor categories). In any case, through the system and method described herein, a composition may be compounded at the point-of-care to generate an optimized treatment for an individual.

### B. Prepare Template (Amplification)

Once the sequence of interest has been identified, a template containing the sequence of interest may be prepared and amplified, as shown in block (310). The template may be a DNA template, such as linear DNA, plasmid DNA, or combinations thereof. The template may comprise an in vitro transcription facilitator cassette (IFC). The IFC may be an in vitro transcription capable double-stranded DNA. The template may be incorporated into an IFC having functional elements that facilitate in vitro transcription (e.g., from an inserted sequence of interest), such as a promoter, a portion encoding a 5′ untranslated region, (5′UTR), a portion encoding a 3′ untranslated region (3′UTR), and a portion encoding for a polyA tail. The IFC may also include one or more linkers (e.g., at least one cleavable site) useful for cloning a sequence of interest into the in vitro transcription facilitator cassette for expression of the sequence of interest and restriction sites to allow for template linearization. An IFC may be manufactured synthetically or non-synthetically.

A sequence of interest useful for inserting into an IFC may be manufactured synthetically or non-synthetically. A sequence of interest may be cleaved prior to combining it with an IFC. In particular, a sequence of interest may be cleaved with the same restriction endonuclease(s) as used to cleave the IFC; but may also be generated through enzymatic amplification. In any case, a template generated in accordance with block (310) of the method shown in FIG. 4 may take various forms. In some versions, the template comprises a uracil-containing polynucleotide sequence.

### C. In Vitro Transcription

A template generated in accordance with block (310) of the method shown in FIG. 4 may be used for subsequent in vitro transcription (IVT) reactions to form a therapeutic polynucleotide, such as therapeutic mRNA, as shown in block (320) of FIG. 4. This IVT process may be conducted inside a process chip such as any of the process chips (111, 200) described herein, with the process being driven by controller (121). Part of this IVT process may include combining the template with reagents such as uracil-N-glycosylase (UNG) enzyme, dNTPs (including dUTP, modified dUTP, and combinations thereof), polymerase, and buffer. The IVT reaction be incubated under controlled conditions to produce capped mRNA molecules. Following the IVT reaction, a DNAse treatment may be performed to degrade the template DNA. This may be performed inside the IVT reaction chamber, and parameters such as dilution rate, enzyme/buffer concentration, temperature and mixing may be controlled to optimized levels. This procedure may be executed autonomously and recorded by a monitoring camera (e.g., one or more of sensors (105)).

D. mRNA Purification

The mRNA generated through the through the IVT process may be purified, as shown in block (330), to remove impurities and side products. In some versions, this purification includes use of cellulose and an ethanol wash. For instance, a cellulose membrane may be used to selectively capture dsRNA under precisely controlled binding conditions and eluting the non-bound fraction a chamber of a process chip such as process chip (111, 200). Another purification step may use 1-2 um carboxyl-coated paramagnetic beads that selectively capture mRNA greater than 500 bp in length. One or more washes may be performed to remove unbound material, such as nucleotides, enzymes, and degraded template. Pure mRNA may then be eluted in USP grade water. A sampling chamber of a process chip (111, 200) may be used for analysis of the purified mRNA. The sampling chamber may receive detection reagents/probes for confirming the content of the resulting, purified mRNA.

E. mRNA Formulation with Delivery Vehicle

The purified mRNA may then be retrieved from the process chip (111, 200) for formulation with a DV, as shown in block (340). In some instances, this formulation process is carried out, at least in part, through a formulation version of process chip (111). Through the formulation process, the purified mRNA may be combined with at least one DV molecule to form an mRNA nanoparticle. For example, an aqueous solution of mRNA cargo may be combined with an ethanolic solution of DV in a microfluidic mixing structure within a formulation version of process chip (111). The material may then undergo two post-formulation processing steps involving first an on-chip dialysis process to exchange buffer components in the formulated product, followed by a concentration step to reduce the volume of the drug product to match specifications. The resulting formulation may yield encapsulated miRNA in the form of amphipathic nanoparticles (ANPs). In some versions, these ANPs are on the order of 100 nm in diameter, or smaller.

In some versions, the DV molecules may include lipitoid-based molecules, such as amino-lipidated peptoids. During the formulation process of block (340), the temperature of mixing stages on the formulation version of process chip (111) may be controlled to a temperature or range of temperatures (e.g., between about 2 degrees C. and about 20 degrees C.) that is calibrated to enhance mixing for mixing in the mixing stages. The enhanced mixing temperature may be based on the formulation being mixed (in some examples the sequence of the mRNA and/or the DV) within the particular geometry of the mixing chamber. Exposure of DV components to aqueous solution and interaction between cationic (+) lipids and anionic (−) mRNA may trigger particle formation. The mRNA may be dissolved in an acidic buffer, which may help ensure full protonation of basic functional groups (e.g., amines) on the DV responsible for its cationic charge. The DV may be dissolved in an aqueous-miscible organic solvent (e.g., ethanol) that facilitates the formation of nano-sized particles upon exposure to the aqueous cargo solution. Immediately after mixing, the solution pH may be stabilized by a neutral buffer.

In some versions, a peptoid-based lipid formulation may be used as the DV, which may incorporate both cationic groups and lipid moieties onto an N-substituted peptide (i.e., peptoid) backbone. The DV components may be monodisperse, fully-characterizable chemical entities. The DV may comprise one or more polyanionic compounds, one or more PEGylated (referring to covalent binding of polyethylene glycol (PEG) molecules) compounds, and one or more cationic compounds. Suitable cationic compounds may include but are not limited to cationic lipids, cationic lipid-peptide conjugates (e.g., lipitoids), cationic peptides, cationic polymers, and lipid-like (lipophilic) cationic compounds. The DV may comprise one or more tertiary amino lipidated and/or PEGylated cationic peptide compounds. The tertiary amino lipidated and/or PEGylated cationic peptide compounds may be peptide chains comprising N-substituted amino acid residues.

A formulation version of process chip (111) may control, with precision, the mixing rate of the material. Faster or slower mixing may be provided and controlled by controller (121). In some versions, immediately following mixing, the ANPs may be diluted with an in-line addition of 1:1 neutral PBS. This may neutralize an acidic formulation buffer and may prepare the formulation for dialysis and concentration. The ANPs created through the formulation process of block (340) may also be evaluated on the formulation version of process chip (111). For instance, the formulation process of block (340) may include a one or more dynamic light scattering (DLS) stages to evaluate particle size, particle distribution, and/or other characteristics of the ANPs. In addition, or in the alternative, a fluorescent mRNA-specific probe may be used to determine RNA concentration before and after particle disruption by addition of a detergent. This assay may elucidate the mRNA concentration for dosing information and the percentage of mRNA encapsulated in the ANPs versus free in solution. Other methods may be used.

### F. Post-Formulation

Once ANPs are formed during the formulation process of block (340), several post-processing operations may be completed on the formulation version of process chip (111), as shown in block (350) of FIG. 4. In some versions, these additional processes may include dialysis for buffer exchange and ethanol removal, followed by evaporative concentration to reduce volume for dosing. Other suitable processing steps may be used. Ultimately, the process may yield a ready-to-use therapeutic polynucleotide composition, as shown in block (360). Such therapeutic compositions may include, but are not limited to, cell therapies, oncological treatments, protein replacement, vaccines, expression of effector proteins, inducement of loss of function through expression of dominant negative proteins, and gene/genome editing. Such therapeutic compositions may be delivered to patients in any suitable fashion.

The various sub-processes referred to in FIG. 4 may be carried out using any suitable number or type(s) of process chip (111). In some versions, the entire process shown in FIG. 4 is carried out using a single version of process chip (111). In some other versions, certain sub-processes are carried out on a dedicated process chip (11), while other sub-processes are carried out on another dedicated process chip (111). For instance, in some versions, template preparation (block 310) is carried out on a dedicated template version of process chip (111); IVT transcription and purification (blocks 320, 330) are carried out on a dedicated IVT version of process chip (111); and formulation (block 340) is carried out on a dedicated formulation version of process chip (111).

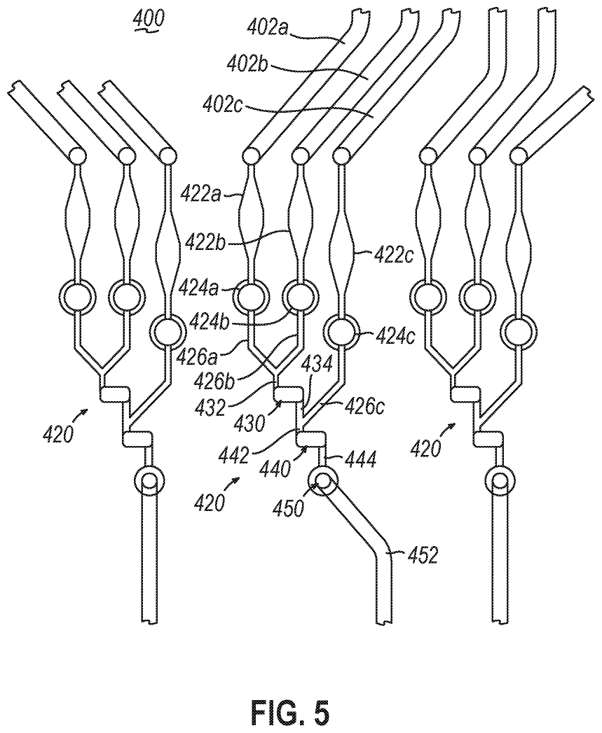

FIG. 5 shows a portion of a process chip (400) that has features that may be used to carry out at least some of the formulation process (block 340). Process chip (400) of this example includes a plurality of fluid channels (402). Each fluid channel (402) has a fluid port (not shown), such that fluid may be communicated to fluid channels (402) via corresponding fluid ports. Some of these fluid ports may receive fluid from corresponding vials in reagent storage frame (107). In addition, or in the alternative, some of these fluid ports may receive fluid from corresponding fluid outputs of another process chip (111, 200). Alternatively, the fluid ports leading to fluid channels (402) may receive fluid from any other suitable sources.

Fluid channels (402) lead to several mixing assemblies (420) that are integrated into process chip (400). In some versions, all mixing assemblies (420) on a process chip (400) have the same kinds of fluid inputs and are intended to all generate the same kind of fluid output. Each mixing assembly (420) includes a set of vacuum caps (422), a set of inlet valves (424), and a set of mixing chambers (430, 440). Referring to one mixing assembly (420) as being representative of the other mixing assemblies (420), mixing assembly (420) includes a first vacuum cap (422a), which receives fluid from a first fluid channel (402a); a second vacuum cap (422b), which receives fluid from a second fluid channel (402b); and a third vacuum cap (422c), which receives fluid from a third fluid channel (402c). Each vacuum cap (422a, 422b, 422c) is configured to evacuate air or other gas from the corresponding fluid channel (402a, 402b, 402c), such that vacuum caps (422a, 422b, 422c) may clear any bubbles, etc., that might otherwise be present. A first valve (424a) selectively prevents or permits the flow of fluid from first vacuum cap (422a) into a first inlet channel (426a) leading toward first mixing chamber (430). A second valve (424b) selectively prevents or permits the flow of fluid from second vacuum cap (422b) into an inlet channel (426b) leading toward first mixing chamber (430). Channels (426a, 426b) converge to form an inlet channel (432) leading into first mixing chamber (430). The fluids from channels (426a, 426b) are thus mixed together Within first mixing chamber (430).

A third valve (424c) selectively prevents or permits the flow of fluid from third vacuum cap (422c) into a third channel (426c) leading toward second mixing chamber (440). An outlet channel (434) from first mixing chamber (430) converges with third channel (426c) to form an inlet channel (442) leading into second mixing chamber (440). The fluids from channels (434, 426c) are thus mixed together within second mixing chamber (440). The fluid mixed in second mixing chamber (440) is output through an outlet channel (444).

In some versions where process chip (400) is used to provide encapsulated mRNA, a combination of mRNA and a formulation buffer may be communicated through first fluid channel (402a) and a DV molecule or molecules in ethanol may be communicated through second fluid channel (402b). In some versions, the formulation buffer includes an aqueous buffer such as a phosphate-citrate buffer solution at a slightly acidic condition (e.g., having a pH of approximately 6.0). Alternatively, any other suitable formulation buffer may be used. The mRNA and DV molecules may thus be combined for encapsulation in first mixing chamber (430). A dilution agent (e.g., a phosphate buffer saline (PBS) solution, etc.) may be communicated through third fluid channel (402c). In such versions, second mixing chamber (440) may thus be used to provide pH adjustment. In some variations, the mRNA and formulation buffer are combined in another mixing chamber (not shown) that is upstream of first fluid channel (402a). Similarly, the DV molecules and ethanol may be combined in another mixing chamber (not shown) that is upstream of second fluid channel (402b).

An additional channel (452) is fluidically coupled with outlet channel (444) via an opening (450). Channel (452) may be fluidically coupled with a collection vial in reagent storage frame (107) (e.g., for storage, etc.), with another process chip (111, 200) (e.g., for further processing, etc.), or with anything else.

In versions where certain sub-processes are carried out on a dedicated process chip (111) while other sub-processes are carried out on another dedicated process chip (111), the same instrument of system (100) may be used with the various process chips (111). In some such versions, the same instrument of system (100) accommodates all the process chips (111) that are needed to carry out the process shown in FIG. 4, such that the instrument of system (100) transfers fluids from one process chip (111) to another process chip (111) at the appropriate stage of the process. In some other versions, an instrument of system (100) only accommodates one single process chip (111) at a time. In some such versions, a portion of the process of FIG. 4 (e.g., template preparation (block (310)) may be carried out using a dedicated process chip (111) with the resulting fluid(s) being stored in one or more vials in reagent storage frame (107). That dedicated process chip (111) may then be removed from the instrument of system (100) and be replaced with another dedicated process chip (e.g., a version of process chip (111) dedicated to performing IVT transcription (block (320))), with that second dedicated process chip receiving fluid from one or more vials in reagent storage frame (107) and/or other sources. Different dedicated process chips (111) may thus be used in an appropriate sequence within the instrument of system (100) to carry out the process of FIG. 4.

### V. Example of Automated Fluid Delivery System

In some scenarios, it may be desirable to provide additional fluid processing capabilities to a system like system (100). For instance, it may be desirable to provide an adjunct fluid processing assembly that interfaces with components of system (100) to allow a user to readily test several samples of reagents in a process carried out through system (100); and readily retrieve several samples of compositions generated through system (100) using the samples of reagents. In some such scenarios, a user may wish to test several samples of mRNA fluid (e.g., a combination of mRNA and formulation buffer, as generated prepared through the IVT and purification processes described above with reference to blocks (320, 330) of FIG. 4) and several samples of DV fluid (e.g., DV molecules in ethanol, as described above) in a formulation process carried out in a process chip (e.g., like process chip (400)), in a formulation process described above with reference to block (340) of FIG. 4); and retrieve the several samples of encapsulated mRNA compositions (e.g., in the form of ANPs) that are formed during the formulation process.

While experimental testing such as that described above may be carried out in system (100), such as by preloading reagent storage frame (107) with the several reagent samples and retrieving the samples of encapsulated mRNA compositions from reagent storage frame (107), an adjunct fluid processing assembly may allow the user to more easily provide a large number of discrete reagent samples and collect a large number of discrete encapsulated mRNA composition samples (e.g., 96 discrete encapsulated mRNA composition samples). In other words, reagent storage frame (107) may, by itself, only have a capacity to hold a certain number of reagent samples, which may limit the usability of reagent storage frame (107) to screen a large number of conditions (e.g., different reagents). For instance, some versions of reagent storage frame (107) may involve a user switching vials in reagent storage frame (107), wash fluid communication channels leading to a process chip and within a process chip, and/or perform other potentially time-consuming operations. An adjunct fluid processing assembly may provide additional fluid storage and processing capabilities relative to the capabilities of reagent storage frame (107), thereby enhancing the number of conditions that may be screened, automating the use of different reagent samples, and automating the washing of fluid channels between reagent samples. An adjunct fluid processing assembly may also provide precise extraction of reagents to thereby prevent or otherwise reduce waste. Several examples of how an adjunct fluid processing assembly may be combined with, or incorporated into, variations of system (100) will be described in greater detail below.

### A. Example of Arrangements of Adjunct Fluid Processing Assemblies

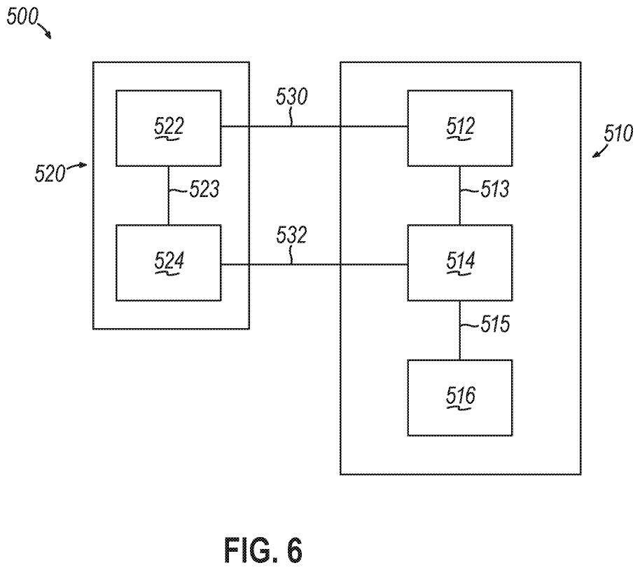

FIG. 6 shows an example of a system (500) that includes an instrument (510) and a separate fluid processing subsystem (520). Instrument (510) of this example may be configured and operable like the instrument of system (100). For instance, instrument (510) of this example includes a controller (512) and an integral fluid processing assembly (514). Controller (512) may be configured and operable like controller (121). Fluid processing assembly (514) may be configured and operable like the combination of pressure source (117), reagent storage frame (107), and fluid interface assembly (109). Controller (512) is coupled with fluid processing assembly (514) via an electrical communication pathway (513), which may include a plurality of wires, traces, other conductive paths, wireless couplings, etc. Controller (512) is thus operable to drive operation of fluid processing assembly (514) via electrical communication pathway (513).

Instrument (510) of this example is also operable to removably receive a process chip (516), which may be configured and operable like any of the variations of process chip (111) described herein. Fluid processing assembly (514) may be coupled with process chip (516) via a fluid communication pathway (515), which may include a plurality of tubes, other fluid conduits, etc. Instrument (510) may also have other components and functionalities similar to those described above with respect to the instrument of system (100).

Fluid processing subsystem (520) of this example includes a controller (522) and a fluid processing assembly (524). Controller (522) may be configured and operable like other controllers (121, 512) described herein. Controller (522) is coupled with fluid processing assembly (524) via an electrical communication pathway (523), which may include a plurality of wires, traces, other conductive paths, wireless couplings, etc. Controller (522) is thus operable to drive operation of fluid processing assembly (524) via electrical communication pathway (523). Controller (522) of fluid processing subsystem (520) is also coupled with controller (512) of instrument (510) via an electrical communication pathway (530), which may include a plurality of wires, traces, other conductive paths, wireless couplings, etc. In some versions, controller (522) may communicate commands, data, and/or other signals to controller (512) via electrical communication pathway (530). In addition, or in the alternative, controller (512) may communicate commands, data, and/or other signals to controller (522) via electrical communication pathway (530). In some variations, electrical communication pathway (530) is omitted, such that controllers (512, 522) are not in electrical communication with each other.

Fluid processing assembly (524) of fluid processing subsystem (520) is coupled with fluid processing assembly (514) of instrument (510) via a fluid communication pathway (532), which may include a plurality of tubes, other conduits, etc. In some versions, fluid processing assembly (524) may communicate fluids to fluid processing assembly (514) via fluid communication pathway (532). In addition, or in the alternative, fluid processing assembly (514) may communicate fluids to fluid processing assembly (524) via fluid communication pathway (532).

Fluid communication pathway (532) may be configured such that fluid communication pathway (532) may be readily separated from, and reconnected with, one or both of fluid processing assemblies (514, 524). Similarly, in versions where electrical communication pathway (530) is present, electrical communication pathway (530) may be configured such that electrical communication pathway (530) may be readily separated from, and reconnected with, one or both of controllers (512, 522). Thus, in some versions, fluid processing subsystem (520) may be readily separated from, and reconnected with, instrument (510). This may be desirable to accommodate different kinds of uses of instrument (510). For instance, some uses of instrument (510) may warrant the additional fluid processing functionality provided via fluid processing subsystem (520), as will be described in greater detail below, in which case a user may wish to couple fluid processing subsystem (520) with instrument (510). Other uses of instrument (510) may not warrant the additional fluid processing functionality provided via fluid processing subsystem (520); in which case a user may wish to decouple fluid processing subsystem (520) from instrument (510).

As an example of how fluid processing assemblies (514, 524) may be used together, a set of reagents may be transferred from fluid processing assembly (524) to process chip (516) via fluid processing assembly (514) and fluid communication pathways (515, 532). These reagents may be processed together via process chip (516) to form a composition. In some such scenarios, one or more other reagents residing on fluid processing assembly (514) (e.g., in a vial supported by a structure like reagent storage frame (107)) may be combined with one or more reagents from fluid processing assembly (524) on process chip (516). The resulting composition may ultimately be communicated back to fluid processing assembly (524) via fluid processing assembly (514) and fluid communication pathways (515, 532). The composition may then be retrieved from fluid processing assembly (524) for further processing. Alternatively, fluid processing assemblies (514, 524) may be used together in any other suitable fashion.

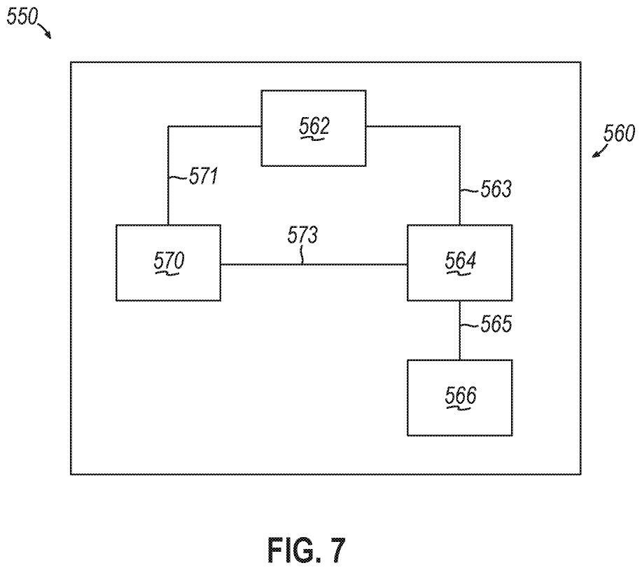

In system (500) of FIG. 6, instrument (510) and fluid processing subsystem (520) are provided as separate components that may be removably coupled together. In some scenarios, it may be desirable to integrate all the features and functionalities of instrument (510) and fluid processing subsystem (520) into a single instrument. To that end, FIG. 7 shows an example of a system (550) that includes a single instrument (560) that removably receives a process chip (566), which may be configured and operable like any of the variations of process chip (111) described herein. Instrument (560) of this example includes a controller (562), a first fluid processing assembly (564), and a second fluid processing assembly (570). Controller (562) may be configured and operable like other controllers (121, 512, 522) described herein. Controller (562) is coupled with first fluid processing assembly (564) via a first electrical communication pathway (563); and with second fluid processing assembly (570) via a second electrical communication pathway (571). Each electrical communication pathway (563, 571) may include a plurality of wires, traces, other conductive paths, wireless couplings, etc. Controller (562) is thus operable to drive operation of first fluid processing assembly (564) via first electrical communication pathway (563); and operation of second fluid processing assembly (570) via second electrical communication pathway (570). While both fluid processing assemblies (564, 570) share the same controller (562) in this example, other versions may provide separate controllers for fluid processing assemblies (564, 570), with such separate controllers being in communication with each other.

First fluid processing assembly (564) may be configured and operable like fluid processing assembly (514) described above. Second fluid processing assembly (570) may be configured and operable like fluid processing assembly (524). First fluid processing assembly (564) is coupled with second fluid processing assembly (570) via a fluid communication pathway (573), which may include a plurality of tubes, other conduits, etc. First fluid processing assembly (564) may also be coupled with process chip (566) via a fluid communication pathway (565), which may include a plurality of tubes, other fluid conduits, etc. In view of the foregoing, system (550) may be operated like system (500). While second fluid processing assembly (570) is integrated into instrument (560) instead of being part of a separate subassembly in this example, some versions of system (550) may nevertheless permit second fluid processing assembly (570) to be selectively coupled with, and decoupled from, controller (562) and first fluid processing assembly (564). In such versions, the presence of second fluid processing assembly (570) may be chosen by the user based on the intended use of system (550).

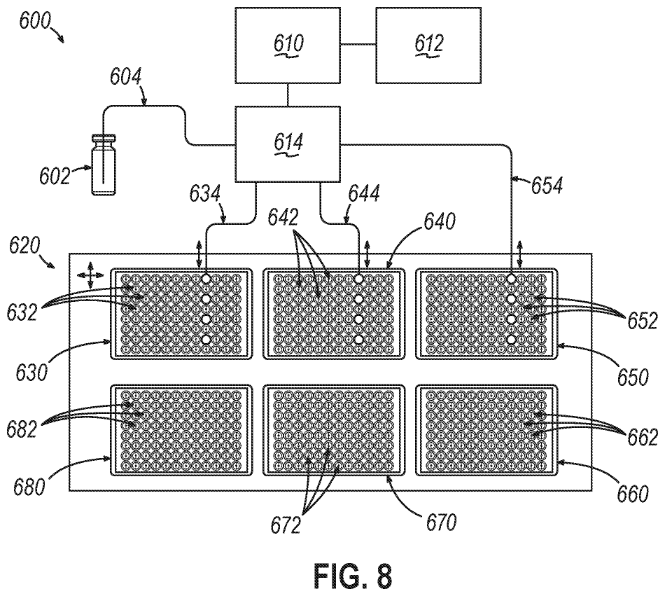

FIG. 8 shows an example of a system (600) that may represent a variation of system (500) and/or system (600) in the context of an illustrative use. In this example, system (600) includes a first fluid processing assembly (610), a process chip (612), and a second fluid processing assembly (614). First fluid processing assembly (610) may be configured and operable like fluid processing assemblies (514, 564). Process chip (612) may be configured and operable like any of the variations of process chip (111) described herein. Second fluid processing assembly (614) may be configured and operable like fluid processing assemblies (524, 570). Fluid processing assemblies (610, 614) may be integrated into a single instrument (e.g., similar to system (550)); or provided separately and coupled together (e.g., similar to system (500)).

System (600) of this example further includes a tray support platform (620), with a plurality of sample trays (630, 640, 650, 660, 670, 680) arranged in a grid on an upper surface (622) of platform (620). Each sample tray (630, 640, 650, 660, 670, 680) defines a plurality of sample wells (632, 642, 651, 662, 672, 682). Each sample well (632, 642, 652, 662, 672, 682) is configured to hold a volume of fluid. Fluid processing assembly (614) includes a plurality of fluid communication pathways (634, 644, 654) that are configured to provide communication of fluid from and/or to sample wells (632, 642, 652, 662, 672, 682). As will be described in greater detail below, fluid processing assembly (614) may be operated such that fluid communication pathways (634, 644, 654) move in relation to sample trays (630, 640, 650, 660, 670, 680) to selectively communicate with sample wells (632, 642, 652, 662, 672, 682). As will also be described in greater detail below, tray support platform (620) may also move in relation to fluid communication pathways (634, 644, 654) to enable fluid communication pathways (634, 644, 654) to reach different sample wells (632, 642, 652, 662, 672, 682).

As also shown in FIG. 8, a separate vial (602) may be coupled with fluid processing assembly (614) via a fluid communication pathway (604). Fluid communication pathway (604) is configured to provide a path for fluid communication from vial (604) to fluid processing assembly (614). As shown, vial (602) is separate from tray support platform (620) in this example. In some versions, vial (602) is integrated into an instrument that contains fluid processing assembly (610) and process chip (612). For instance, vial (602) may be integrated into an assembly like reagent storage frame (107). While only one vial (602) is shown, system (600) may include more than one vial (602). Moreover, a vial (602) is just one example of a fluid-containing structure that may be provided separately from tray support platform (6200. Other suitable kinds of fluid-containing structures may be used.

In an example of use for system (600), system (600) may be used to perform mRNA formulation as described above in the context of block (340) of FIG. 4. In some such scenarios, process chip (612) of system (600) may be configured and operated like process chip (400) shown in FIG. 5. Each sample tray (630, 640, 650, 660, 670, 680) may be dedicated to serve a certain purpose. For instance, sample tray (630) may serve as a collection tray, such that sample wells (632) receive encapsulated mRNA that was formulated on process chip (612). Such encapsulated mRNA (e.g., in the form of ANPs) may be communicated to sample wells (632) of sample tray (630) via fluid processing assemblies (610, 614) and fluid communication pathway (634). When process chip (612) is configured like process chip (400), the encapsulated mRNA may be communicated from channels like channel (452). As will be described in greater detail below, fluid processing assemblies (610, 614) and fluid communication pathway (634) may communicate encapsulated mRNA from several channels like channel (452) in process chip (612) to several corresponding sample wells (632) of sample tray (630) simultaneously.

Sample tray (640) may serve as an mRNA source tray, such that sample wells (642) contain mRNA fluid that is used in the formulation process on process chip (612). Such mRNA fluid may include a combination of mRNA and formulation buffer; and may be prepared through the IVT and purification processes described above with reference to blocks (320, 330) of FIG. 4. Such mRNA fluid from sample tray (640) may be communicated to process chip (612) via fluid processing assemblies (610, 614) and via fluid communication pathway (644). When process chip (612) is configured like process chip (400), the mRNA fluid from sample tray (640) may be communicated to channels like channel (402a). As will be described in greater detail below, fluid processing assemblies (610, 614) and fluid communication pathway (644) may communicate mRNA fluid from several sample wells (642) to several corresponding channels like channel (402a) on process chip (612) simultaneously.

Sample tray (650) may serve as a DV fluid source tray, such that sample wells (642) contain DV fluid that is used in the formulation process on process chip (612). Such DV fluid may include DV molecules in ethanol, as described above. Such DV fluid from sample tray (650) may be communicated to process chip (612) via fluid processing assemblies (610, 614) and via fluid communication pathway (654). When process chip (612) is configured like process chip (400), the DV fluid from sample tray (640) may be communicated to channels like channel (402b). As will be described in greater detail below, fluid processing assemblies (610, 614) and fluid communication pathway (654) may communicate DV fluid from several sample wells (652) to several corresponding channels like channel (402b) on process chip (612) simultaneously.

Sample trays (660, 670) may serve as rinse fluid source trays, such that sample wells (662, 670) contain rinse fluid that is used to rinse fluid communication pathways (644, 654). When process chip (612) is configured like process chip (400), the rinse fluid may also rinse channels (402a, 402b) and structures downstream of channels. Such rinse fluid may include a combination of water and ethanol. Alternatively, any other suitable rinse fluid may be used. In some versions, rinse fluid in sample tray (660) is used to rinse components of fluid communication pathway (654) and channel (402b) while rinse fluid in sample tray (670) is used to rinse components of fluid communication pathway (644) and channel (402a). In some other versions, rinse fluid in sample tray (660) is used to perform a first rinsing stage for components of fluid communication pathways (644, 654); while rinse fluid in sample tray (670) is used to perform a second rinsing stage for components of fluid communication pathways (644, 654). In some such versions, the rinse fluid in sample tray (660) is different from the rinse fluid in sample tray (670).

Sample trays (680) may be used to collect waste from the rinsing process referred to above. Sample wells (682) may thus receive waste fluid from fluid communication pathway (634). When process chip (612) is configured like process chip (400), sample wells (682) may also receive waste from channel (452) and structures upstream of channel (452).

Vial (602) may provide a dilution agent (e.g., a PBS solution, etc.) that is used in the formulation process on process chip (612). Such buffer solution from vial (602) may be communicated to process chip (612) via fluid processing assemblies (610, 614) and via fluid communication pathway (604). When process chip (612) is configured like process chip (400), the dilution agent from vial (602) may be communicated to channels like channel (402c). As will be described in greater detail below, fluid processing assemblies (610, 614) and fluid communication pathway (604) may communicate dilution agent from vial (602) to several corresponding channels like channel (402c) on process chip (612) simultaneously.

In some other variations, vial (602) may contain mRNA that is used in the formulation process, while sample wells (642) may contain the buffer solution. As another variation, vial (602) may contain the DV fluid, while sample wells (652) may contain the buffer solution. As yet another variation, the buffer solution, mRNA, and DV fluid may all be contained in their own respective sample trays, such that vial (602) may be omitted.

B. Example of Method of Utilizing Automated Fluid Delivery System with Adjunct Fluid Processing Assembly

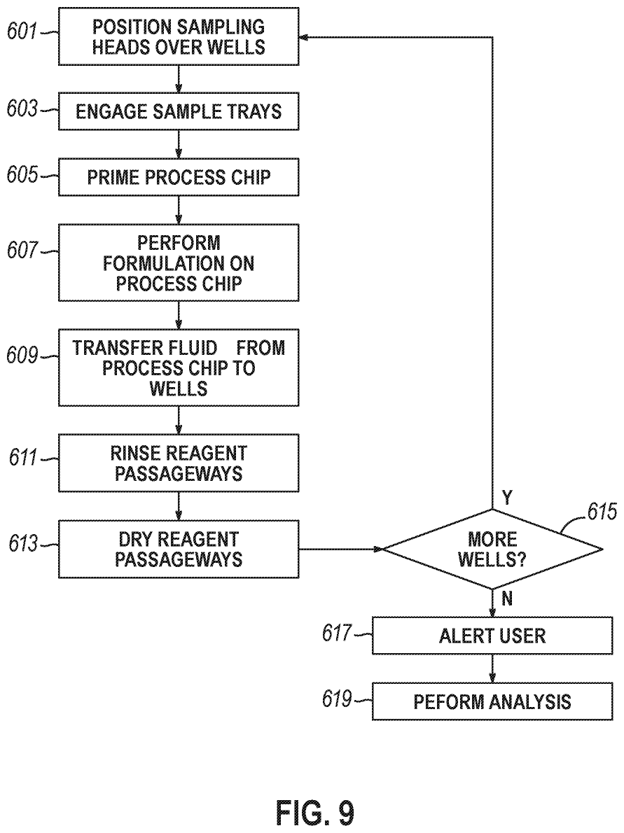

FIG. 9 depicts an example of a method of operation that may be carried out using any of the various systems (500, 550, 600) described above. In some versions, this method is carried out for screening purposes, to determine which combination of variables yield the most suitable encapsulated mRNA through a formulation process on a process chip (516, 566, 612) like process chip (400). Such variables may include, but are not necessarily limited to, reagent types, buffer compositions, DV formulations, reagent concentrations, reagent mass ratios, processing temperatures, fluid flow rates, fluid flow rate ratios, etc. Alternatively, this method may be used for any other suitable purpose(s). The following description will be provided in the context of system (600), though it should be understood that the following description may be readily applied to systems (500, 550) and other variations.

In the context of a screening use, the process may begin with sample trays (630, 640, 650, 660, 670, 680) securely positioned on tray support platform (620). Sampling head assemblies (not shown) of fluid communication pathways (634, 644, 654) may be positioned over targeted sample wells (632, 642, 652), as shown in block (601) of FIG. 9. With sample wells (632, 642, 652) appropriately positioned in relation to sampling head assemblies of fluid communication pathways (634, 644, 654), the sampling head assemblies may be actuated to engage sample trays (630, 640, 650), as shown in block (603) of FIG. 9.

Next, the process may include priming fluid passageways on process chip (612), as shown in block (605) of FIG. 9. In arrangements such as those shown in FIG. 6, and as described in greater detail below, this priming may include activating the sampling head assemblies of fluid communication pathways (634, 644) to drive reagent fluids from sample wells (642, 652) toward process chip (612) via fluid communication pathways (634, 644), fluid processing assembly (614), and fluid processing assembly (610). The priming may also include activating one or both of fluid processing assemblies (610, 614) to drive reagent fluid (e.g., buffer) from vial (602) toward process chip (612) via fluid communication pathway (604) and fluid processing assemblies (610, 614). In some versions, the priming process includes driving the fluid at a pressure of approximately 0.3 psi. In addition, the priming process may include driving the fluid at a flow rate ranging from approximately 100 microliters per minute to approximately 400 microliters per minute.

In some versions, the priming process represented by block (605) in FIG. 9 is automated. In some such versions, the sampling head assemblies of fluid communication pathways (634, 644) are automatically activated to drive reagent fluids from sample wells (642, 652) as described above after sample trays (640, 650) have been suitably engaged (as represented by block (603) in FIG. 9), until such reagent fluids reach a predetermined location on process chip (612). Simultaneously, one or both of fluid processing assemblies (610, 614) may be automatically activated to drive reagent fluid from vial (602). Once the reagent fluids reach the predetermined location on process chip (612), the fluid communication may cease until further input is provided. In some such versions, one or more sensors (e.g., sensors (105)) are used to track fluid movement on process chip (516, 566, 612), such that the one or more sensors may communicate the presence of the reagent fluids in the predetermined location to a controller (e.g., controller (121, 512, 522, 562)); and such that the controller may then automatically stop further communication of reagent fluid until further input is provided. Examples of how such an arrangement and process may be carried out will be described in greater detail below.

In some versions where process chip (612) is configured like process chip (400), the predetermined locations to monitor for auto-priming from sample wells (642, 652) may be located along fluid channels (402a, 402b), such that fluid processing assembly (614) (or whatever other component is driving the flow or reagent fluid) may at least temporarily stop driving the flow reagent fluid along fluid channels (402a, 402b) before the reagent fluid flows through first mixing chamber (430). In such cases, some fluid flow hysteresis may result, such that some small quantity (e.g., one or two drops, etc.) of reagent fluid may still flow even after fluid processing assembly (614) (or whatever other component is driving the flow or reagent fluid) at least temporarily stops driving the flow reagent fluid.

In versions where process chip (612) is configured like process chip (400) and a separate vial (602) is used to provide a buffer fluid, the predetermined location to monitor for auto-priming from vial (602) may be located along fluid channel (402c), such that fluid processing assembly (614) (or whatever other component is driving the flow or buffer fluid) may at least temporarily stop driving the flow of the buffer fluid before the buffer fluid flows through second mixing chamber (440). In such cases, some fluid flow hysteresis may result, such that some small quantity (e.g., one or two drops, etc.) of buffer fluid may still flow even after fluid processing assembly (614) (or whatever other component is driving the flow or buffer fluid) at least temporarily stops driving the flow buffer fluid.

In versions where a controller (e.g., controller (121)) automatically stops further driving of reagent fluid in response to the fluid reaching the predetermined location, such automatic stoppage may include automatically transitioning valves (424a, 424b, 424c) to a closed state. As noted above, some small quantity (e.g., one or two drops, etc.) of fluid may still flow briefly as a result of hysteresis after valves (424a, 424b, 424c) are transitioned to a closed state. It is therefore contemplated that such fluid flow hysteresis may occur in some scenarios regardless of whether the communication of fluid flow is ceased by fluid processing assembly (614) (or whatever other component is driving the flow or fluid) at least temporarily stopping driving the flow of the fluid and/or by valves (424a, 424b, 424c) transitioning to a closed state.

In versions providing auto-priming where the controller automatically stops further communication of reagent fluid in a primed fluid channel (402a, 402b, 402c) until further input is provided, such further input may include a user input. For instance, the controller may notify the user (e.g., via user interface (123)) that all the appropriate fluid channels (402a, 402b, 402c) within process chip (612) have been suitably primed, then await user input (e.g., approval) before moving forward with subsequent stages of the process. As another variation, the controller may track priming of all fluid channels (402a, 402b, 402c) within process chip (612), and then automatically proceed with subsequent stages in the process after controller has determined that all the appropriate fluid channels (402a, 402b, 402c) within process chip (612) have been suitably primed.

Once process chip (612) has been suitably primed, the process may continue with formulation being performed on process chip (612), as represented by block (607) in FIG. 9. This formulation process may be carried out in accordance with the above description referencing blocks (340, 350) of FIG. 4 to yield encapsulated mRNA (e.g., in the form of ANPs). In some versions, the formulation process may be completed in less than 10 milliseconds. The fluid containing the encapsulated mRNA created through the formulation process may be communicated to appropriate sample wells (632) in sample tray (630) via fluid communication pathway (634), as represented by block (609) in FIG. 9. This communication of fluid containing the encapsulated mRNA to sample wells (632) may include activating process chip (612), fluid processing assembly (610), and/or fluid processing assembly (614) to drive the fluid containing the encapsulated mRNA to appropriate sample wells (632) in sample tray (630) via fluid communication pathway (634).

While the formulation and collection stages are shown in separate blocks (607. 609) in FIG. 9, these stages may in fact overlap in time. For instance, reagent fluids may be communicated from corresponding sample wells (642, 652) in sample trays (640, 650) while fluid containing encapsulated mRNA is being communicated to other sample wells (632) in sample tray (630). To conclude the communication of encapsulated mRNA to appropriate sample wells (632) in sample tray (630), as represented by block (609) of FIG. 9, a purging volume of air may be communicated through fluid communication pathways (644, 654); and the other fluid communication components that are downstream of these fluid communication pathways (644, 654), including corresponding passageways in process chip (612). In some versions, this purge may be accomplished after reagent fluid has been evacuated from sample wells (642, 650), such that further communication of pressurized air via fluid communication pathways (644, 654) will eventually reach fluid communication pathway (634).

After the fluid containing the encapsulated mRNA has been communicated to appropriate sample wells (632) in sample tray (630), including the air purge described above, the process may then include rinsing of reagent passageways within system (600), as represented by block (611) of FIG. 9. As part of the rinsing procedure, system (600) may reposition fluid communication pathway (634) over sample wells (682) of sample tray (680), reposition fluid communication pathway (644) over sample wells (672) of sample tray (670), and reposition fluid communication pathway (654) over sample wells (662) of sample tray (660). Once sample wells (662, 672) containing rinse fluid are appropriately positioned in relation to corresponding fluid passageways (644, 654), system (600) may be actuated to drive the rinse fluid through fluid passageways (644, 654) and the other fluid communication components that are downstream of fluid passageways (644, 654), including corresponding passageways in process chip (612). The rinse fluid may thus rinse these components. During the rinsing process represented by block (611) of FIG. 9, the waste fluid generated through rinsing may be communicated to dedicated sample wells (682) in a sample tray (680) via fluid passageway (634). Thus, sample wells (682) may readily receive waste fluid via fluid communication pathway (634) while rinse fluid is communicated from sample wells (662, 672) via fluid communication pathways (644, 654).

After a suitable volume of rinse fluid has been communicated through fluid communication pathways (644, 654) and the other fluid communication components that are downstream of fluid communication pathways (644, 654), these fluid passageways may be dried, as represented by block (613) of FIG. 9. This drying process may include communicating pressurized air through fluid communication pathways (644, 654) and the other fluid communication components that are downstream of fluid communication pathways (644, 654), including corresponding passageways in process chip (612). In some versions, this drying may be accomplished after rinse fluid has been evacuated from sample wells (662, 672), such that pressurized air communicated through empty sample wells (662, 672) will flow back through fluid communication pathways (644, 654) via the empty sample wells (662, 672). The pressurized air may flow further through the other fluid communication components that are downstream of through fluid communication pathways (644, 654), eventually exiting fluid communication pathway (634). The pressurized air may flow for any suitable duration to achieve a desired state of dryness.

Once the drying has been completed, the controller (e.g., controller (121)) may determine whether there are additional sample wells (642, 652) from which to draw reagents, as represented by block (615) of FIG. 9. If there are additional sample wells (642, 652) from which to draw reagents, the process may then provide positioning of fluid communication pathways (644, 654) over the next set of targeted sample wells (632, 642, 652), as shown in block (601) of FIG. 9. The above-described stages represented by blocks (601, 603, 605, 607, 609, 611, 613, 615) may be reiterated until there are no longer any additional sample wells (642, 652) from which to draw reagents.

Once there are no longer any additional sample wells (642, 652) from which to draw reagents, the process may alert the user that all reagents have been used, as represented by block (617) of FIG. 9. In some versions, this alert may include an audible alert such as a beep or other audible notification. In addition, or in the alternative, this alert may include a visual alert such as an illuminated light, a graphical and/or textual message on a user interface (e.g., user interface (123)), or other visual notification. In versions where system (600) is coupled with a network, the alert may include a text message, email message, or other kind of message conveyed over the network to the user. Alternatively, any other suitable kind(s) of user alert(s) may be provided. In some version, a user alert is omitted. The user alert represented by block (617) of FIG. 9 is thus optional.

After the foregoing stages has been completed, the user may retrieve the fluid containing encapsulated mRNA and perform testing to determine suitability of the encapsulated mRNA, as represented by block (619) of FIG. 9. This may include removing sample tray (630) from tray support platform (620) and then retrieving the fluid containing encapsulated mRNA from sample wells (632). In some other versions, the fluid containing encapsulated mRNA is retrieved from sample wells (632) before sample tray (630) is removed from tray support platform (620). While system (600) is configured to deposit the fluid containing encapsulated mRNA in sample wells (632) in the present example, other variations may deposit the fluid containing encapsulated mRNA in other kinds of containers (e.g., vials, etc.).

As part of the analysis represented by block (619) of FIG. 9, the user may analyze the fluid containing encapsulated mRNA to determine various properties of the encapsulated mRNA and the fluid in which the mRNA is contained. Such properties may include, but are not necessarily limited to, encapsulation rate, particle size, particle distribution, zeta potential, in-vitro bioactivity, in-vivo bioactivity, biodistribution in an animal (e.g., in a targeted organ), toxicity, stability, etc. In some variations, system (600) includes one or more integral features that are operable to perform at least some analysis on the fluid containing encapsulated mRNA. For instance, system (600) may include a dynamic light scattering stage that is operable to detect particle size and particle distribution in the fluid containing encapsulated mRNA.

In versions where system (600) includes one or more features that may perform automated analysis of the fluid containing encapsulated mRNA, system (600) may be further configured to provide real-time adjustments to delivery of reagents to process chip (612) in response to results of such testing. In other words, the integrated testing features may be used to provide a feedback loop that allows a controller of system (600) to attempt to refine the formulation process to yield more desirable results.

In some scenarios, a system (600) such as those described above may be operable to execute the above process and yield 96 discrete samples of fluid containing encapsulated mRNA in sample wells (632) in a sample tray (630) in less than two hours. In some instances, this overall processing time may be substantially faster than the processing time that might otherwise be needed to yield a similar number of samples of fluid containing encapsulated mRNA using a system like system (100), without an adjunct fluid processing assembly (614).

In the present example, all sample wells (642) contain the same formulation of a first kind of reagent (e.g., mRNA), and all sample wells (652) contain the same formulation of a second kind of reagent (e.g., DV molecules), such that the above-described process may be used to perform 96 tests of the same formulation process using the same formulation inputs. In some other versions, different sample wells (642) contain different formulations of a first kind of reagent, and different sample wells (652) contain different formulations of a second kind of reagent, such that these different formulations may be tested through the process described above. While sample trays (630, 640, 650, 660, 670, 680) of the present example each have 96 sample wells (632, 642, 652, 662, 672, 682), sample trays (630, 640, 650, 660, 670, 680) may instead have more or fewer than 96 sample wells (632, 642, 652, 662, 672, 682). While systems (500, 550, 600) are described above in the context of performing screening for mRNA formulation processes, systems (500, 550, 600) may be used in any other suitable kinds of processes.

### VI. Example of Components and Methods to Detect and React to Presence of Fluid in a Passageway

As noted above with reference to block (605) of FIG. 9, it may be desirable during operation of a fluid processing system, like any of the systems (500, 550, 600) described above, to detect the presence of fluid within a certain region of interest in the system. In the example provided above, this may be desirable during a priming process. For instance, when priming fluid channels (402a, 402b) with reagent fluids, and/or when priming fluid channel (402c) with a buffer fluid, it may be desirable to determine when such fluid has reached vacuum cap (422a, 422b, 422c) or some other predetermined location upstream of valve (424a, 424b, 424c); and arrest further communication of fluid through such fluid channel (402a, 402b, 402c) until some further condition is met. Such a further condition may include a state where all fluid channels (402) on process chip (400) have been suitably primed (e.g., filled with fluid up to vacuum cap (422a, 422b, 422c) or some other predetermined location upstream of valve (424a, 424b, 424c)). In addition, or in the alternative, such a further condition may include receipt of a user input indicating that a fluid processing process should proceed on process chip (400) after process chip (400) has been suitably primed. The following describes examples of components and methods that may be used to provide automated priming of a process chip (400), other fluid conveying components within systems (500, 550, 600), and/or other kinds of fluid conveying devices. While the following examples are provided in the context of process chip (400) and the process shown in FIG. 9, the following example may be applied to other devices and other processes.

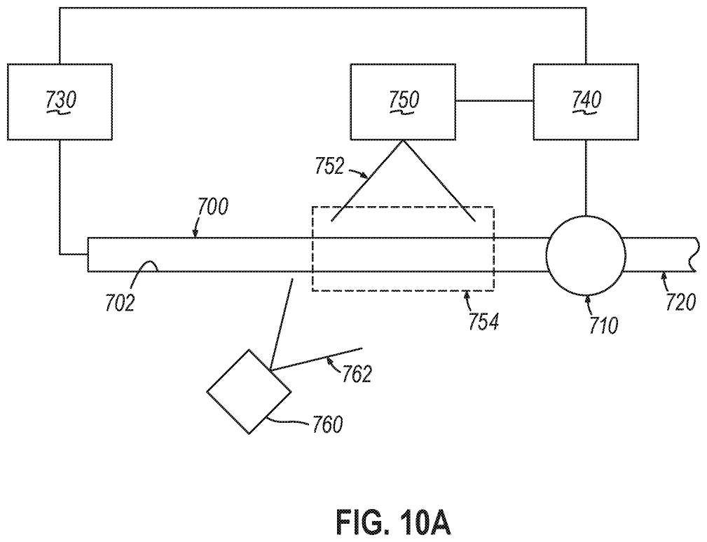

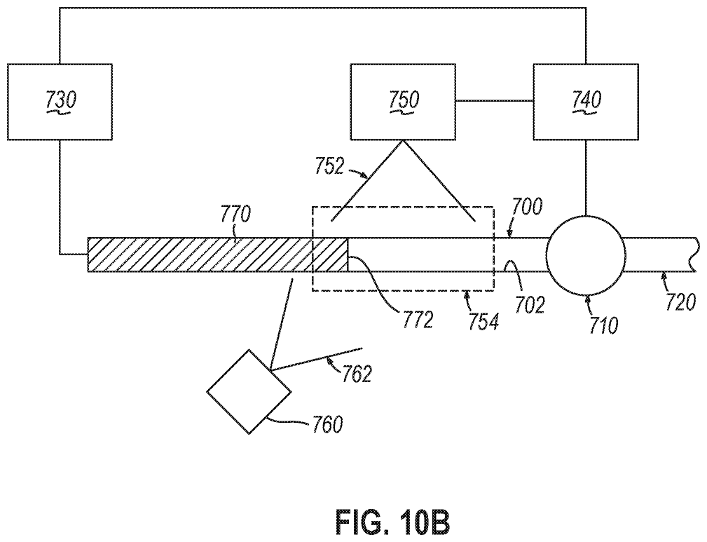

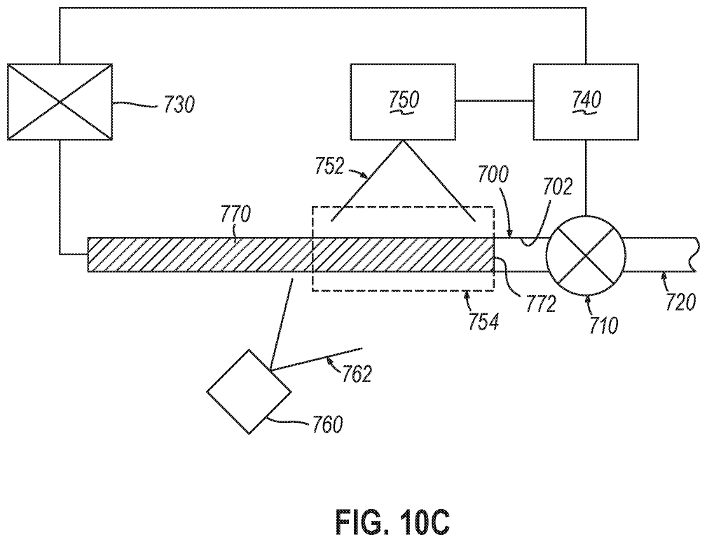

FIGS. 10A-10C show an arrangement of several components that may be incorporated into a fluid processing system like any of the systems (500, 550, 600) described above. These components include a fluid channel (700), a valve (710), a fluid processing assembly (730), a controller (740), a camera (750), and a light source (760). Fluid channel (700) may represent any of fluid channels (402a, 402b, 402c) of process chip (400), other fluid channels as described herein, or any other suitable fluid channels. Fluid channel (700) may be formed in a process chip or other body that is transparent (or otherwise substantially translucent). Valve (710) may represent any of valves (424a, 424b, 424c) of process chip (400), other valves as described herein, or any other suitable valves. Fluid processing assembly (730) may represent any of fluid processing assemblies (514, 524, 570, 564, 610, 614) as described herein or any other suitable fluid processing assemblies, including combinations thereof. Controller (750) may represent any of controllers (121, 512, 522, 562) as described herein or any other suitable controller, including combinations thereof.

Camera (750) may take any suitable form. In some versions, camera (750) comprises an RGB camera (e.g., with a CMOS sensor) that is operable to capture images at 21 frames per second. In some versions, camera (750) represents one or more of optical sensors (160) described above. Thus, camera (750) may be utilized for the functionalities described above with reference to optical sensors (160) in addition to being utilized for the functionality described below. In some other versions, camera (750) is provided in addition to optical sensors (160) described above. In some such versions, camera (750) is dedicated to the functionality described below. In any case, images captured by camera (750) are processed by controller (740) to execute the process described in further detail below.

Camera (750) of the present example has a field of view (752) that includes a region of interest (754) of fluid channel (700). Region of interest (754) is just upstream of valve (710). In the present example, region of interest (754) is located in a region where channel (700) would be deemed in a primed state once the region of the channel (700) has sufficiently received fluid (770).

While FIGS. 10A-10C show field of view (752) as encompassing a single region of interest (754), field of view (752) may encompass a larger area that includes region of interest (754). For instance, field of view (752) may encompass an entire process chip that has several fluid channels (700); and each fluid channel (700) may have its own region of interest (754). Field of view (752) may thus encompass a plurality of regions of interest (754) simultaneously. Field of view (752) is thus not necessarily limited to a single region of interest (754). In versions where a plurality of regions of interest (754) are captured within a single field of view (752), image data from those regions of interest (754) may be processed simultaneously (e.g., in parallel) as will be described in greater detail below.

Light source (760) may also take any suitable form (e.g., one or more light emitting diodes, etc.). As noted above, system (100) may include one or more sources of light (e.g., electroluminescent panels, etc.) to provide illumination that aids in optical sensing by optical sensors (160). Light source (760) may represent one or more of such sources of light in system (100). Thus, light source (760) may be utilized for the functionalities described above in addition to being utilized for the functionality described below. In some other versions, light source (760) is provided in addition to the one or more sources of light described above. In some such versions, light source (760) is dedicated to the functionality described below. Light source (760) of the present example is operable to generate incoherent projected light (762). This may be desirable in some instances to prevent damage to particles in fluid (770) or other potentially adverse effects on fluid (770). In some other versions, light source is operable to generate coherent projected light (762).

While light source (760) is not depicted in FIGS. 10A-10C as being coupled with controller (740), light source (760) may be powered by controller (740) in some versions. In addition to having a powered light source (760), or in lieu of having a powered light source (760), ambient lighting may be used. In any case, projected light (762) illuminates region of interest (754) in the present example.

In the process depicted in FIGS. 10A-10C, camera (750) is used to determine when fluid (770) has sufficiently reached region of interest (754) in fluid channel (700), such as when leading edge (772) of fluid (770) reaches an end of region of interest (754). Controller (740) is used to automatically cease communication of fluid (770) in fluid channel (700) in response to camera (750) detecting that fluid (770) has sufficiently reached region of interest (754) in fluid channel (700). In the stage shown in FIG. 10A, fluid (770) is not yet flowing in channel (700). In the stage shown in FIG. 10B, fluid (770) is flowing in channel (700); and leading edge has entered region of interest (754) but not yet reached the end of region of interest (754). In the stage shown in FIG. 10C, fluid (770) has reached the end of region of interest (754), such that controller (740) has activated valve (710) to transition from an open state to a closed state. In the closed state depicted in FIG. 10C, valve (710) prevents fluid (770) from reaching a downstream region (720) of channel (700). In some versions, fluid (770) is transparent (or otherwise substantially translucent).

In the example described above, valve (710) is used to prevent fluid (770) from reaching downstream region (720) of channel (700). In addition to closing valve (710), or as an alternative to closing valve (710), other techniques may be used to prevent fluid (770) from reaching downstream region (720) of channel (700). In some such scenarios, the pump, sampling head, or other fluid driving feature (e.g., pressurized fluid cartridge) is part of fluid processing assembly (730), such that the fluid driving feature pushes fluid (770) along channel (700). In addition, or in the alternative, the fluid driving feature may be downstream of downstream region (720), such that the fluid driving feature pulls fluid (770) along channel (700). The pumping action may be active or passive.

The use of camera (750) to optically detect fluid may be particularly challenging in cases where fluid (770) is transparent (or otherwise substantially translucent), the process chip or other body defining fluid channel (700) is transparent (or otherwise substantially translucent), and camera (750) is not picking up fluorescence of fluorophores in fluid (770). In other words, there may be a substantial lack of contrast between fluid (770) and the process chip or other body defining fluid channel (700), particularly when fluid (770) and the process chip or other body defining fluid channel (700) are both transparent (or otherwise substantially translucent).

To the extent that the human eye may perceive the presence or absence of a transparent (or otherwise substantially translucent) fluid in a transparent (or otherwise substantially translucent) process chip or other body defining a fluid channel (700), the detection of fluid in such conditions may be difficult in an automated system that relies on machine vision. However, the use of machine vision may be desirable to provide greater fluid processing speed than might otherwise be achieved in versions relying on perception by a human eye. The following describes an example of an automated image processing method that may be used to account for the substantial lack of contrast between fluid (770) and the process chip or other body defining fluid channel (700). This method may effectively determine the position of leading edge (772) in a sequence of images by focusing on optical differences perceived at the interface between the boundary layer of fluid (770) and sidewall (702) of fluid channel (700) over time. In some versions, projected light (762) from light source (760) assists in optically emphasizing the boundary layer of fluid (770) at sidewall (702) of fluid channel (700). For instance, the boundary layer of fluid (770) at sidewall (702) may illuminate (i.e. reflect light) with a higher intensity than the rest of fluid (770) in channel (700).

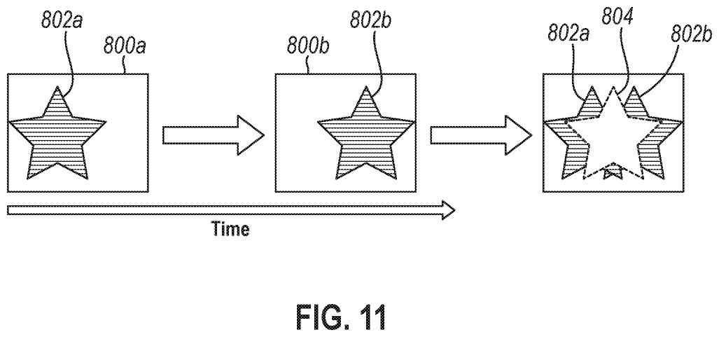

FIG. 11 shows a schematic representation of an algorithm that may be executed by controller (740) while processing a series of images successively captured by camera (750). In this example, a first image frame (800a) captures the position of an object (802a) at a first moment in time; while a second image frame (800b) captures the position of the same object (802b) at a subsequent moment in time. Referring back to the arrangement shown in FIGS. 10A-10C, image frames (800a, 800b) may be captured at the same region of interest (772); and object (802a, 802b) may represent fluid (770). Returning to FIG. 11, controller (740) processes image frames (800a, 800b) to compare the position of object (802b) at the second moment in time with the position of object (802a) at the first moment in time to generate a representation (804). This comparison may include subtracting image frame (800b) from image frame (800a). Representation (804) represents the absolute difference between the position of object (802a) at the first moment in time and the position of the same object (802b) at the subsequent moment in time. If the absolute difference of representation (804) exceeds a threshold, then controller (740) may trigger an effect (e.g., stopping the flow of fluid (770)) in response to representation (804) exceeding the threshold.

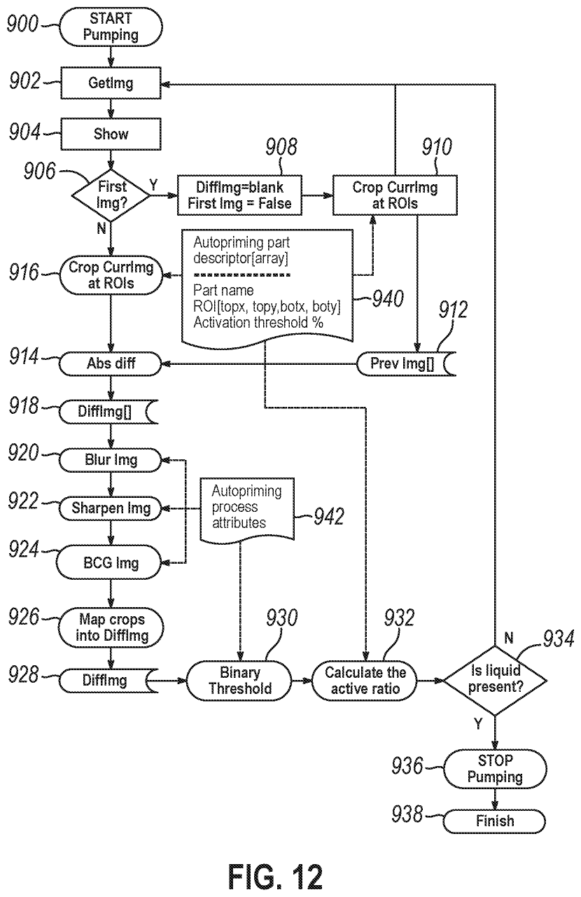

FIG. 12 shows an example of a detailed process that may be carried out using the components shown in FIGS. 10A-10C. In this example, several parameters may be established to influence execution of certain parts of the process. The parameters may be defined before the process begins. For instance, as indicated by block (940) of FIG. 12, these predefined parameters may include the name of the component in which fluid channel (700) is located, the coordinates defining the boundaries of region of interest (754), and a threshold value for the absolute difference of representation (804). Such parameters may be used during cropping stages represented by blocks (906, 910) described below, during the calculation of an active ratio as represented by block (932), and/or at other stages of the process. As indicated by block (942) of FIG. 12, the predefined parameters may also include image processing attributes that are used during the blurring; sharpening; and brightness, contrast, and gamma (BCG) stages represented by blocks (920, 922, 924) descried below; and/or at other stages of the process. The predefined parameters may be stored in controller (740).

In the example depicted in FIG. 12, the process starts when fluid (770) is pumped through fluid channel (700), as shown in block (900) of FIG. 12. As noted above, this pumping action may be provided by fluid processing assembly (730), one or more components downstream of valve (710), and/or any other suitable components.

As fluid (700) is pumped through fluid channel (700), camera (750) captures an image that includes region of interest (754), as shown in block (902) of FIG. 12. As part of this image capture stage of block (902), the captured image may be immediately converted to grayscale. In some versions as noted above, the field of view (752) of camera (750) includes a plurality of regions of interest (754). In such versions, all of these regions of interest (754) may be within the captured image. The image captured by camera (750) is communicated to controller (740), as shown in block (904) of FIG. 12. Controller (740) then determines whether the captured image is the first captured image, as shown in block (906). If the captured image is the first captured image, controller (740) leaves blank a “DiffImg” value, as shown in block (908). As described in greater detail below, this “DiffImg” value may represent light intensity differences between two images that are captured in a sequence, with the two images being captured immediately adjacent to each other in time.

As also shown in block (908), controller (740) assigns a “False” designation to a “First Img” value when controller (740) determines that the image at hand is the first image acquired during the process of FIG. 12. Before reaching the stage shown in block (908), the Boolean flag represented by the “First Img” value may have a “True” designation, such that the “First Img” Boolean flag value changes from “True” to “False” as a result of the first image is processed through stage shown in block (908). For shorthand purposes, the image at hand (i.e., the most recently captured image that is currently being processed by controller (740)) may be referred to herein (and in FIG. 12) as “CurrImg.”

Next, controller (740) crops the CurrImg at each region of interest (754), as shown in block (910). As noted above, this may include only one region of interest (754) in some versions; or several regions of interest (754) in other versions. The remaining description of the process of FIG. 12 will be provided in the context of the process as carried out within one region of interest (754). However, the same stages of the process as described below may be carried out simultaneously with respect to several regions of interest (754) from the same CurrImg. Thus, the process may be used to monitor for the presence of fluid (770) in several different fluid channels (700) simultaneously. The cropping of the CurrImg at each region of interest (754) may be performed using the predefined parameters (i.e., region of interest (754) boundaries) as noted above with reference to block (940).

The cropped image is stored as shown in block (912). In some versions, the cropped image is stored on controller (740). In FIG. 12, the stored, cropped image is shown with a designation “Prev Img.” In versions where the CurrImg includes a plurality of regions of interest (754), each Prev Img may be stored with a corresponding index number (e.g., “Prev Img 001,” “Prev Img 002” “Prev Img 003,” etc.). In addition, or in the alternative, the Prev Img cropped images may be stored as an array.

The process proceeds with capturing another image, as shown in block (902) and described above. This subsequently captured image is communicated to controller (740), as shown in block (904). Controller (740) then determines whether the subsequently captured image is the first captured image, as shown in block (906). Upon determining that this subsequently captured image (which is now designated as “CurrImg”) is not the first captured image, controller (740) crops the CurrImg at each region of interest (754), as shown in block (916). The cropping of the CurrImg at each region of interest (754) may be performed using the predefined parameters (i.e., region of interest (754) boundaries) as noted above with reference to block (940).

As shown in block (914), controller (740) then compares the previously captured, cropped image (stored as “Prev Img” in block (912)) with the cropped version of the CurrImg (as cropped in block (916)) to generate an absolute difference between the two images, similar to representation (804) described above. This comparison may include subtracting the CurrImg from the Prev Img to generate representation (804). Each representation (804) so generated may provide data indicating an absolute change in light intensity at the boundary layer of fluid (770) at sidewall (702) in the CurrImg relative to the Prev Img. In scenarios where each captured image includes several regions of interest (754), this comparison may be performed between image data from each region of interest (754) from the two moments in time—the first being associated with the first captured image and the second being associated with the second captured image. In other words, the sequence of images of each region of interest (754) may be compared in parallel with the comparison of the sequence of images of the other regions of interest (754).

The absolute difference between each pair of images, similar to representation (804) described above, may be stored as part of an array, as shown in block (918). As shown in FIG. 12, each representation (804) of the absolute difference between the sequence of images may be stored in an array with a “DiffImg [ ]” representation. In versions where each CurrImg includes a plurality of regions of interest (754), the “DiffImg [ ]” array includes the absolute difference between the sequence of images as cropped for each region of interest (754), such that the absolute differences are stored together in an array in the stage of the process indicated by block (918). In other words, the “DiffImg[ ]” shown in block (918) may include an array of representations (804).

Next, each absolute difference image (e.g., representation (804)) may be subjected to a blurring process, as shown in block (920); followed by a sharpening process, as shown in block (922). In some versions, the blurring and sharpening processes may be performed via cross-convolution using different Gaussian kernel filters. Alternatively, any other suitable blurring and sharpening methods may be used. Controller (740) then applies brightness, contrast, and gamma (BCG) correction to the image, as shown in block (924). These image processing stages represented by blocks (920, 922, 924) may be performed using the predefined parameters as noted above with reference to block (942). In some versions, these predefined parameters may define the blurring kernel (e.g. a 3×3 matrix), the sharpening kernel (e.g., a 3×3 matrix), the BCG values, upper and lower threshold boundaries, etc. The image processing stages represented by blocks (920, 922, 924) (and a grayscale conversion, if performed) may assist in removing noise from the image, such that the processed image data may more clearly emphasize any reflected light intensity data from the boundary layer of fluid (770) at sidewall (702) in region of interest (754).

Controller (740) then maps the absolute difference images (e.g., representations (804)) into a single, larger image, as shown in block (926). This single, larger image may include all the regions of interest (754), such that the single, larger image includes all the absolute difference images (e.g., representations (804)). This single, larger image may is shown in block (926) with the representation “DiffImg.”

After performing the image processing stages represented by blocks (920, 922, 924) and mapping the crops as represented by block (926), the resulting DiffImg may be stored again as shown in block (928). The DiffImg may then be converted to a binary image, as shown in block (930). This conversion to a binary image may be accomplished via thresholding. The resulting binary image may provide spatial information of changes between the CurrImg and the Prev Img, which may include a clear indication of the extent to which the boundary layer of fluid (770) at sidewall (702) has illuminated (which may indicate the degree to which fluid (770) has filled channel (700)). The conversion to a binary image as shown in block (930) may be performed using the predefined parameters as noted above with reference to block (942). Such predefined parameters may include upper and/or lower threshold boundaries.

With the binary image generated, controller (740) may calculate an active ratio as shown in block (932). This “active ratio” may be defined as the number of pixels at the interface between the boundary layer of fluid (770) and sidewall (702) that are illuminated (indicating the presence of fluid (770)) within region of interest (754) with respect to the total number of pixels at sidewall (702) within region of interest (754). In other words, the “active ratio” may be expressed as a percentage of how many of the total number pixels at sidewall (702) within region of interest (754) are illuminated (indicating the presence of fluid (770)). In some other versions, the “active ratio” is defined as the number of pixels at the interface between the boundary layer of fluid (770) and sidewall (702) that are illuminated (indicating the presence of fluid (770)) within region of interest (754) with respect to the total number of pixels within the entire region of interest (754). In such versions, the “active ratio” may be expressed as a percentage of how many of the total number pixels within the entire region of interest (754) are illuminated along sidewall (702) (indicating the presence of fluid (770)). In either case, the ratio calculation represented by block (932) may be performed using predefined parameters as noted above with reference to block (940).

In the state shown in FIG. 10A, the active ratio indicates that the portion of channel (700) within region of interest (754) is 0% filled with fluid (770). In the state shown in FIG. 10B, the active ratio indicates that the portion of channel (700) within region of interest (754) is filled with some amount of fluid that is greater than 0% but less than 100%. In the state shown in FIG. 10C, the active ratio indicates that the portion of channel (700) within region of interest (754) is 100% filled with fluid.

With the active ratio calculated, controller (740) may determine whether fluid (770) is sufficiently present in region of interest (754). This determination may include determining whether the active ratio has met a predefined threshold. The value for the active ratio threshold may be selected to avoid interpreting noise as indicating a sufficient amount of fluid (770) in channel (700). In some versions, the active ratio threshold is 5%. In some other versions, the active ratio threshold is 25%. Alternatively, any other suitable active ratio threshold may be used. Thus, while the process depicted in FIGS. 10A-10C depicts valve (710) not being closed until fluid (770) fills the entire portion of channel (700) in region of interest (754), other variations may provide closure of valve (710) after fluid (770) enters region of interest (754) but before fluid (770) fills the entire portion of channel (700) in region of interest (754).

In the event that the active ratio indicates that fluid (770) is not sufficiently present in region of interest (754), controller (740) may capture another image, as shown in block (902), and reiterate the process shown in FIG. 12 repeatedly until the active ratio indicates that fluid (770) is sufficiently present in region of interest (754).

Once the active ratio indicates that fluid (770) is sufficiently present in region of interest (754), controller (740) may cease communication of fluid (770) through channel (700) associated with that region of interest (754), as shown in block (936). As described above with reference to FIG. 10C, this may include controller (740) activated valve (710) to transition from an open state to a closed state. In addition to closing valve (710), or as an alternative to closing valve (710), controller (740) may initiate other actions to cease communication of fluid (770) through channel (700). Such other actions may include deactivating a pump that is upstream of channel (700) (e.g., in fluid processing assembly (730), deactivating a pump that is downstream of channel (700), and/or other actions.

After controller (740) has ceased communication of fluid (770) through channel (700), the process may end, as shown in block (938). In versions where several channels (700) are within the field of view (752) of camera (750), and each image captured by camera (750) includes several regions of interest (754), the above process may be carried out for each region of interest (754) in parallel. In some scenarios, different channels (700) within the same device (e.g., process chip (400), etc.) may sufficiently fill with fluid (770) at different rates. In such scenarios, the above process may be reiterated until the desired number of channels (700) have been sufficiently filled with fluid (770). For those fluid channels (700) that sufficiently fill before others, such filled fluid channels (700) may remain filled and idle until the remaining fluid channels (700) are sufficiently filled.

After the desired number of channels (700) have been sufficiently filled with fluid (770), any suitable subsequent process may be carried out. In some versions, such as where the process of FIG. 12 is carried out with respect to fluid channels (402) of process chip (400), an mRNA formulation process as described above with reference to block (340) of FIG. 4 may be carried out via process chip (400) after fluid channels (402) of process chip (400) have been sufficiently filled with fluid (770) (e.g., mRNA fluid, DV fluid, and a buffer). In some such versions, the mRNA formulation process is automatically carried out as soon as the process of FIG. 12 results in a determination that all fluid channels (402) of process chip (400) have been sufficiently filled with fluid (770). In some other versions, a user may be automatically notified when the process of FIG. 12 results in a determination that all fluid channels (402) of process chip (400) have been sufficiently filled with fluid (770); and the user may need to provide further input to move forward with further processing such as mRNA formulation. In either case, such processes may be carried out while process chip (400) is integrated into any of the systems (100, 500, 550, 600) described above. Alternatively, the process of FIG. 12 may be carried out using any other suitable components and as part of any other larger process.

As noted above, camera (750) may be operable to capture images at 21 frames per second. In some versions, the process described above with reference to FIG. 12 is performed on each of the 21 frames per second that are captured by camera (750). Alternatively, camera (750) may capture images at any other suitable frame rate; and those frames may be processed in the process described above with reference to FIG. 12 at any other suitable rate.

While the foregoing priming examples are provided in the context of priming fluid channels (402a, 402b, 402c) in process chip (400), the above priming teachings may be applied to other components. For instance, the above priming teachings may be applied to other fluid conveying components within a process chip (400), other fluid conveying components within a fluid processing assembly (514, 524, 570, 564, 610, 614, 730), or other fluid conveying components in other kinds of assemblies. The above priming teachings may be applied to fluid channels, valves, chambers, pumps, and any other suitable kinds of structures that are configured to convey or otherwise receive fluid. Moreover, the above teachings may be applied to non-priming contexts. For instance, the above teachings may be applied to provide clog detection within a process chip, fluid processing assembly, or other structure that is configured to convey or otherwise receive fluid. The above teachings may also be applied to provide detection of bubbles within a process chip, fluid processing assembly, or other structure that is configured to convey or otherwise receive fluid. The above teachings may also be applied to provide monitoring of a volume of fluid within a process chip, fluid processing assembly, or other structure that is configured to convey or otherwise receive fluid.

### VII. Miscellaneous

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art without departing from the scope of the subject technology. For instance, different numbers of a given module or unit may be employed, a different type or types of a given module or unit may be employed, a given module or unit may be added, or a given module or unit may be omitted.

Some versions of the examples described herein may be implemented using a computer system, which may include at least one processor that communicates with a number of peripheral devices via bus subsystem. Versions of the examples described herein that are implemented using a computer system may be implemented using a general-purpose computer that is programmed to perform the methods described herein. Alternatively, versions of the examples described herein that are implemented using a computer system may be implemented using a specific-purpose computer that is constructed with hardware arranged to perform the methods described herein. Versions of the examples described herein may also be implemented using a combination of at least one general-purpose computer and at least one specific-purpose computer.

In versions implemented using a computer system, each processor may include a central processing unit (CPU) of a computer system, a microprocessor, an application-specific integrated circuit (ASIC), other kinds of hardware components, and combinations thereof. A computer system may include more than one type of processor. The peripheral devices of a computer system may include a storage subsystem including, for example, memory devices and a file storage subsystem, user interface input devices, user interface output devices, and a network interface subsystem. The input and output devices may allow user interaction with the computer system. The network interface subsystem may provide an interface to outside networks, including an interface to corresponding interface devices in other computer systems. User interface input devices may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

In versions implemented using a computer system, a user interface output device may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system to the user or to another machine or computer system.

In versions implemented using a computer system, a storage subsystem may store programming and data constructs that provide the functionality of some or all of the modules and methods described herein. These software modules may be generally executed by the processor of the computer system alone or in combination with other processors. Memory used in the storage subsystem may include a number of memories including a main random-access memory (RAM) for storage of instructions and data during program execution and a read only memory (ROM) in which fixed instructions are stored. A file storage subsystem may provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem in the storage subsystem, or in other machines accessible by the processor.

In versions implemented using a computer system, the computer system itself may be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the example of the computer system described herein is intended only as a specific example for purposes of illustrating the technology disclosed. Many other configurations of a computer system are possible having more or fewer components than the computer system described herein.

As an article of manufacture, rather than a method, a non-transitory computer readable medium (CRM) may be loaded with program instructions executable by a processor. The program instructions when executed, implement one or more of the computer-implemented methods described above. Alternatively, the program instructions may be loaded on a non-transitory CRM and, when combined with appropriate hardware, become a component of one or more of the computer-implemented systems that practice the methods disclosed.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A system comprising:
an optical sensor having a field of view, the field of view positioned to include a first fluid channel defined by a body; and
a processor, the processor to:
receive a first image including a region of interest of the first fluid channel,
receive a second image including the region of interest of the first fluid channel, the second image being captured after the first image,
generate a comparison of the second image to the first image,
generate a binary image using the comparison,
use the binary image to determine whether a first fluid is present in the region of interest of the first fluid channel, and
if the processor determines that the first fluid is present in the region of interest of the first fluid channel, cease communication of the first fluid through the first fluid channel.

2. The system of claim 1, further comprising a camera, the camera including the optical sensor.

3. The system of claim 1, the field of view positioned to further include a second fluid channel defined by the body, the first image further including a region of interest of the second fluid channel, the second image further including the region of interest of the second fluid channel, the processor further to:
determine whether a second fluid is present in the region of interest of the second fluid channel, and
if the processor determines that the second fluid is present in the region of interest of the second fluid channel, cease communication of the second fluid through the second fluid channel.

4. The system of claim 3, the processor to simultaneously determine whether the first fluid is present in the region of interest of the first fluid channel and determine whether the second fluid is present in the region of interest of the second fluid channel.

5. The system of claim 3, the field of view positioned to further include a third fluid channel defined by the body, the first image further including a region of interest of the third fluid channel, the second image further including the region of interest of the third fluid channel, the processor further to determine whether the third fluid is present in the region of interest of the third fluid channel.

6. The system of claim 5, the processor further to initiate a fluid process using the first fluid channel, the second fluid channel, and the third fluid channel if the processor determines that the first fluid is present in the region of interest of the first fluid channel, the second fluid is present the region of interest of the second fluid channel, and the third fluid is present in the region of interest of the third fluid channel.

7. The system of claim 6, the fluid process including an mRNA formulation process.

8. The system of claim 1, further comprising a fluid processing assembly, the fluid processing assembly having a fluid driving feature to drive the first fluid through the first fluid channel, the processor being in communication with the fluid processing assembly, the processor to cease communication of the first fluid through the first fluid channel by deactivating the fluid driving feature of the fluid processing assembly.

9.-15. (canceled)

16. The system of claim 1, the processor to use the binary image to determine whether the first fluid is present in the region of interest of the first fluid channel by calculating a ratio.

17. The system of claim 16, the ratio including a ratio of a first set of pixels to a second set of pixels, the first set of pixels including pixels showing reflected light at an interface between a boundary layer of fluid in the region of interest of the fluid channel and a sidewall of the fluid channel, the second set of pixels including pixels along an entire length of the sidewall of the fluid channel in the region of interest.

18. The system of claim 1, further comprising:
a chip-receiving component, the chip-receiving component to removably receive the body; and
the body removably coupled with the chip-receiving component.

19.-20. (canceled)

21. The system of claim 18, the body comprising a substantially translucent material surrounding the first fluid channel.

22. The system of claim 18, the body including:
a plurality of fluid channels, the plurality of fluid channels including the first fluid channel, and
a plurality of mixing chambers, the mixing chambers to mix fluids communicated along the plurality of fluid channels.

23. The system of claim 22, the body further including a plurality of valves, each valve of the plurality of valves being positioned along a corresponding fluid channel of the plurality of fluid channels, each valve of the plurality of valves to selectively prevent fluid from flowing in the corresponding fluid channel of the plurality of fluid channels, the processor to cease communication of fluid through the plurality of fluid channels by activating the plurality of valves.

24. (canceled)

25. A method comprising:
receiving a first image including a region of interest of a first fluid channel while a first fluid is being communicated toward the first fluid channel;
receiving a second image including the region of interest of the first fluid channel, the second image being captured after the first image;
generating a comparison of the second image to the first image;
generating a binary image using the comparison;
using the binary image to determine whether the first fluid is present in the region of interest of the first fluid channel; and
if using the binary image to determine whether the first fluid is present in the region of interest of the first fluid channel indicates that the first fluid is present in the region of interest first fluid channel, ceasing communication of the first fluid through the first fluid channel.

26.-29. (canceled)

30. The method of claim 25, the first image further including a region of interest of a second fluid channel while a second fluid is being communicated toward the second fluid channel, the second image further including the region of interest of the second fluid channel, the method further comprising:
determining whether the second fluid is present in the region of interest of the second fluid channel; and
if determining whether the second fluid is present in the region of interest of the second fluid channel indicates that the second fluid is present in the region of interest of the second fluid channel, ceasing communication of the second fluid through the second fluid channel.

31. (canceled)

32. The method of claim 30, the first image further including a region of interest of a third fluid channel while a third fluid is being communicated toward the third fluid channel, the second image further including the region of interest of the third fluid channel, the method further comprising determining whether fluid present in the region of interest of the third fluid channel.

33. (canceled)

34. The method of claim 32, the first fluid including an mRNA fluid, the second fluid including a delivery vehicle fluid, the third fluid including a buffer fluid.

35. The method of claim 34, the fluid process including an mRNA formulation process.

36.-45. (canceled)

46. A processor-readable medium including contents that are configured to cause a processor to process data by performing the following:
receiving a first image including a region of interest of a first fluid channel while a first fluid is being communicated toward the first fluid channel;
receiving a second image including the region of interest of the first fluid channel, the second image being captured after the first image;
generating a comparison of the second image to the first image;
generating a binary image using the comparison;
using the binary image to determine whether the first fluid is present in the region of interest of the first fluid channel; and
if using the binary image to determine whether the first fluid is present in the region of interest of the first fluid channel indicates that the first fluid is present in the region of interest first fluid channel, ceasing communication of the first fluid through the first fluid channel.
